(19) United States
(12) Patent Application Publication
(10) Pub. No.: US 2017/0277887 A1
(43) Pub. Date: Sep. 28, 2017

(54) INFORMATION PROCESSING APPARATUS, INFORMATION PROCESSING METHOD, AND COMPUTER READABLE MEDIUM

(71) Applicant: MITSUBISHI ELECTRIC CORPORATION, Tokyo (JP)

(72) Inventors: Hideaki IJIRO, Tokyo (JP); Shoji SAKURAI, Tokyo (JP); Kiyoto KAWAUCHI, Tokyo (JP)

(73) Assignee: MITSUBISHI ELECTRIC CORPORATION, Tokyo (JP)

(21) Appl. No.: 15/506,674

(22) PCT Filed: Nov. 14, 2014
(86) PCT No.: PCT/JP2014/080252

§ 371 Date: Feb. 24, 2017

(51) Int. Cl. G06F 21/55; G06F 21/56

(52) U.S. Cl. CPC G06F 21/552; G06F 21/554; G06F 21/567; G06F 2221/034

(57) ABSTRACT

A candidate event derivation unit (101) derives, as a candidate event, an event predicted to occur in an information system (200) including a plurality of system components (300), the event being a candidate for a monitoring target. An attribute identification unit (102) derives, as a candidate system component, a system component (300) involved in occurrence of the candidate event from among the plurality of system components (300), and identifies an attribute of the candidate system component. A monitoring target decision unit (103) analyzes the attribute of the candidate system component identified by the attribute identification unit (102), and decides whether or not the candidate event is to be the monitoring target.

### TECHNICAL FIELD

The present invention relates to a technique for detecting an attack on an information system.

### BACKGROUND ART

As an example of the attack on the information system, there is a targeted attack.

In the targeted attack, it is difficult to distinguish between an authorized activity and an attack activity since an attacker performs an activity by impersonating an authorized user.

In order to distinguish between the authorized activity and the attack activity adequately, it is required to tune a detection rule for attack detection.

However, in a conventional integrated log monitoring, it was difficult to tune the detection rule to keep balance between detection leakage and a detection error of the attack.

As to this, a method has been proposed in which a sequence of events observed through the activity of the attacker is defined as a scenario, and when the occurrence of the events according to the scenario is observed, the attack is considered to have occurred (for example, Non-Patent Literature 1).

Specifically, in the method of Non-Patent Literature 1, attack activity definition information is defined for each of a plurality of events considered to occur in the targeted attack.

The attack activity definition information defines the contents of the event, a precondition for the event to occur, and an achieved state indicating new knowledge or a state and the like expected to be obtained by the attacker from the occurrence of the event.

In a detection of targeted attack, targeted attack detection S/W (Software) receives the event sent from a security device such as a STEM (Security Information and Event Management), then when the targeted attack detection S/W finds that the likelihood of the targeted attack is high, a warning is issued to an administrator.

When the likelihood of the targeted attack is not high enough to issue the warning, the targeted attack detection S/W predicts an event that will occur next by utilizing the attack activity definition information corresponding to the received event.

Further, using the predicted event as needed, the targeted attack detection S/W changes monitoring setting on the SIEM and an device on monitoring target network in order to perform more detailed monitoring.

However, a problem arises in the method of the Non-Patent Literature 1 that, depending on how the attack activity definition information is defined, a large number of events predicted to occur next appears and a high load is applied for monitoring the event.

That is, in the method of Non-Patent Literature 1, for monitoring the event, for example, a problem arises that a high search load is applied when the trace of the attack is analyzed from a log.

As to this, there are prior arts in which an event that is not subjected to monitoring is defined in advance using a whitelist (for example, Patent Literatures 1 to 4).

Further, there is an art which sets an event which has been excluded from a monitoring target as the monitoring target afterward (Patent Literature 5).

### CITATION LIST

### Patent Literature

Patent Literature 1: JP 2006-53788 A
Patent Literature 2: JP 2006-65835 A [JP 4624181 B2]
Patent Literature 3: JP 2006-163931 A [JP 4420804 B2]
Patent Literature 4: JP 2007-94997 A [JP 4619254 B2]
Patent Literature 5: JP 2008-59552 A [JP 4041845 B1]

### Non-Patent Literature

Non-Patent Literature 1: Kiyoto Kawauchi, Hiroyuki Sakakibara, and Shoji Sakurai, “Proposal of a Cyber-Attack Detection Method Using Scenarios”, SCIS 2014, Jan. 23, 2014.

### SUMMARY OF INVENTION

### Technical Problem

In a method using the whitelist, it is required to prepare the whitelist in which a condition for excluding from the monitoring target is defined for each event.

A number of events considered to occur in the targeted attack is enormous, and in the method for deciding whether or not the event is to be the monitoring target by referring to whitelists each of which is defined for each event, it is required to search a large number of whitelists for a whitelist to be referred to.

Therefore, in the method using the whitelist, an operation load is high and long operation time is needed.

The present invention has been conceived in view of these circumstances and mainly aims to realize a configuration capable of reducing an operation load and operation time needed for deciding whether or not an event is to be a monitoring target.

### Solution to Problem

An information processing apparatus according to the present invention includes:

a candidate event derivation unit to derive, as a candidate event, an event predicted to occur in an information system including a plurality of system components, the event being a candidate for a monitoring target;

an attribute identification unit to derive, as a candidate system component, a system component involved in occurrence of the candidate event from among the plurality of system components, and identify an attribute of the candidate system component; and

a monitoring target decision unit to analyze the attribute of the candidate system component identified by the attribute identification unit, and decide whether or not the candidate event is to be the monitoring target.

### Advantageous Effects of Invention

In the present invention, it is decided whether or not a candidate event is to be a monitoring target based on an attribute of a system component. The number of system components is remarkably less than the number of events.

Therefore, an operation load and operation time needed for deciding whether or not the candidate event is to be the monitoring target can be reduced.

### BRIEF DESCRIPTION OF DRAWINGS

FIG. 1 is a diagram illustrating a configuration example of an information system and an information processing apparatus according to a first embodiment.

FIG. 2 is a flowchart diagram illustrating an operation example of the information processing apparatus according to the first embodiment.

FIG. 3 is a diagram illustrating a configuration example of an attack event prediction apparatus according to the first embodiment.

FIG. 4 is a diagram illustrating an example of an attack event definition information according to the first embodiment.

FIG. 5 is a diagram illustrating an example of an achieved state information according to the first embodiment.

FIG. 6 is a flowchart diagram illustrating an operation example of the attack event prediction apparatus according to the first embodiment.

FIG. 7 is a diagram illustrating an example of an attack event definition information according to the first embodiment.

FIG. 8 is a diagram illustrating an example of a temporary candidate event definition information according to the first embodiment.

FIG. 9 is a diagram illustrating an example of an achieved state information according to the first embodiment.

FIG. 10 is a diagram illustrating an example of a candidate event definition information according to the first embodiment.

FIG. 11 is a diagram illustrating a configuration example of an attack event prediction apparatus according to a second embodiment.

FIG. 12 is a diagram illustrating an example of configuration information of File1 according to the second embodiment.

FIG. 13 is a diagram illustrating an example of configuration information of H_1 according to the second embodiment.

FIG. 14 is a diagram illustrating an example of configuration information of USER1 according to the second embodiment.

FIG. 15 is a diagram illustrating an example of configuration information stored in a configuration information database according to the second embodiment.

FIG. 16 is a diagram illustrating an example of configuration information stored in the configuration information database according to the second embodiment.

FIG. 17 is a diagram illustrating an example of an exclusion rule list according to the second embodiment.

FIG. 18 is a flowchart diagram illustrating an operation example of the attack event prediction apparatus according to the second embodiment.

FIG. 19 is a diagram illustrating a monitoring event-determination information generation unit, a monitoring event determination unit, and a determination result processing unit according to the second embodiment.

FIG. 20 is a flowchart diagram illustrating an operation example of the monitoring event-determination information generation unit, the monitoring event determination unit, and the determination result processing unit according to the second embodiment.

FIG. 21 is a diagram illustrating a configuration example of an attack event prediction apparatus according to a third embodiment.

FIG. 22 is a diagram illustrating an example of an exclusion event information table according to the third embodiment.

FIG. 23 is a flowchart diagram illustrating an operation example of the attack event prediction apparatus according to the third embodiment.

FIG. 24 is a diagram illustrating a configuration example of the information system and an information processing apparatus according to a fourth embodiment.

FIG. 25 is a flowchart diagram illustrating an operation example of the information processing apparatus according to the fourth embodiment.

FIG. 26 is a diagram illustrating a configuration example of an attack event prediction apparatus according to the fourth embodiment.

FIG. 27 is a flowchart diagram illustrating an operation example of the attack event prediction apparatus according to the fourth embodiment.

FIG. 28 is a flowchart diagram illustrating an example of an acquired monitoring event definition information according to the fourth embodiment.

FIG. 29 is a flowchart diagram illustrating an example of an acquired achieved state information according to the fourth embodiment.

FIG. 30 is a diagram illustrating a configuration example of a database management tool according to a fifth embodiment.

FIG. 31 is a flowchart diagram illustrating an operation example of the database management tool according to the fifth embodiment.

FIG. 32 is a flowchart diagram illustrating an example of an editing screen of the attack event definition information according to the fifth embodiment.

FIG. 33 is a flowchart diagram illustrating an example of an editing screen of the exclusion rule according to the fifth embodiment.

FIG. 34 is a diagram illustrating a hardware configuration example of the information processing apparatus according to the first to fifth embodiments.

### DESCRIPTION OF EMBODIMENTS

### First Embodiment

***Description of Configuration of Information Processing Apparatus 100***

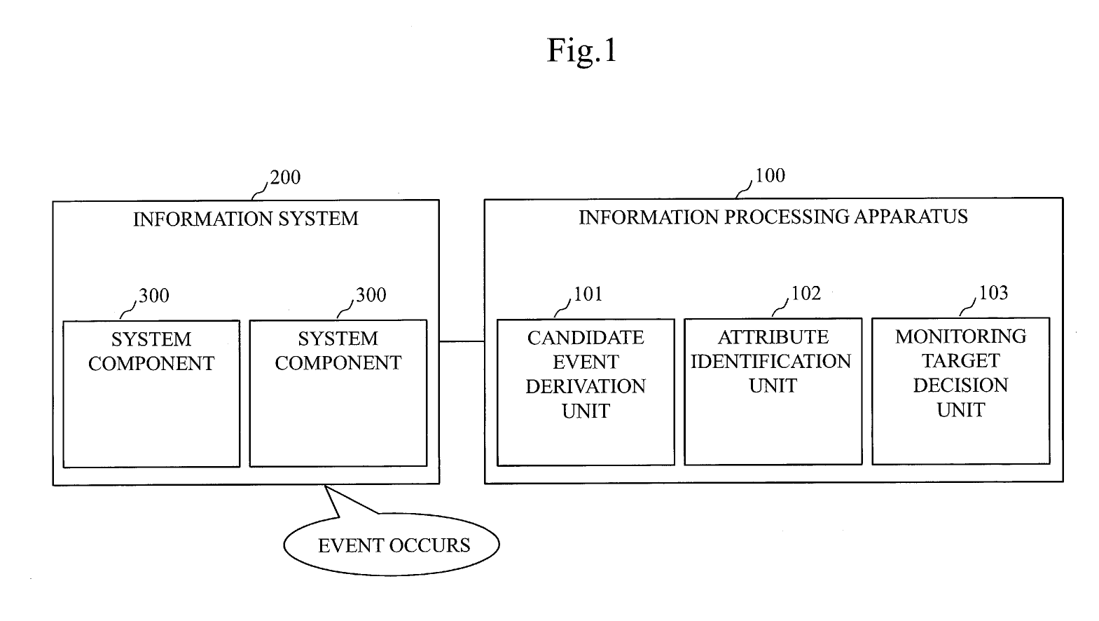

FIG. 1 illustrates a configuration example of an information processing apparatus 100 and an information system 200 according to the present embodiment.

The information system 200 includes a plurality of system components 300.

A system component 300 includes computer factors such as a terminal apparatus and a server apparatus.

Further, the system component 300 includes human factors such as a user who utilizes the terminal apparatus and a system administrator who manages the information system 200.

Furthermore, the system component 300 includes data factors such as a file, a table, a function, a variable, and a constant.

Further, an event occurs in the information system 200 and a security device such as a SIEM included in the information system 200 detects an attack symptom event (to be referred to as an attack event hereinafter) being a symptom of an attack on the information system 200.

The attack symptom event detected by the security device is notified to the information processing apparatus 100.

In the information processing apparatus 100, a candidate event derivation unit 101 derives, as a candidate event, an event predicted to occur in the information system 200 and is to be a candidate for a monitoring target.

For example, the candidate event derivation unit 101 derives, as the candidate event, the event predicted to occur in the information system 200 when the information system 200 is attacked.

More specifically, when the attack symptom event is notified by the security device of the information system 200, the candidate event derivation unit 100 derives, as the candidate event, the event predicted to occur in the information system 200 subsequent to the attack symptom event.

Note that, “monitoring” means to investigate the presence or absence of the occurrence of the event by searching a log or the like regularly or irregularly in order to analyze how far the attack progresses.

For example, assume an scenario based on which a progress stage of the attack is recognized to have been progressed from level 1 to level 2 when an event B occurs after an event A occurred.

In this case, after the event A occurred, the event B predicted to occur next is assigned to be the monitoring target, and it is determined whether or not the event B has occurred by searching the log regularly or irregularly.

Then, when the occurrence of the event B is confirmed by searching the log, it is found out that the progress stage of the attack has been progressed to level 2.

An attribute identification unit 102 derives, as a candidate system component, a system component involved in the occurrence of the candidate event from among the plurality of system components 300.

“Involved” means to include a system component being a subject of the occurrence of the candidate event, a system component being an object of the candidate event, a system component utilized as a parameter in the candidate event, and the like.

Further, the attribute identification unit 102 identifies an attribute of the candidate system component.

A monitoring target decision unit 103 analyzes the attribute of the candidate system component identified by the attribute identification unit 102, and decides whether or not the candidate event is to be the monitoring target.

***Description of Operation of Information Processing Apparatus 100***

Nextly, an operation example of the information processing apparatus 100 will be described.

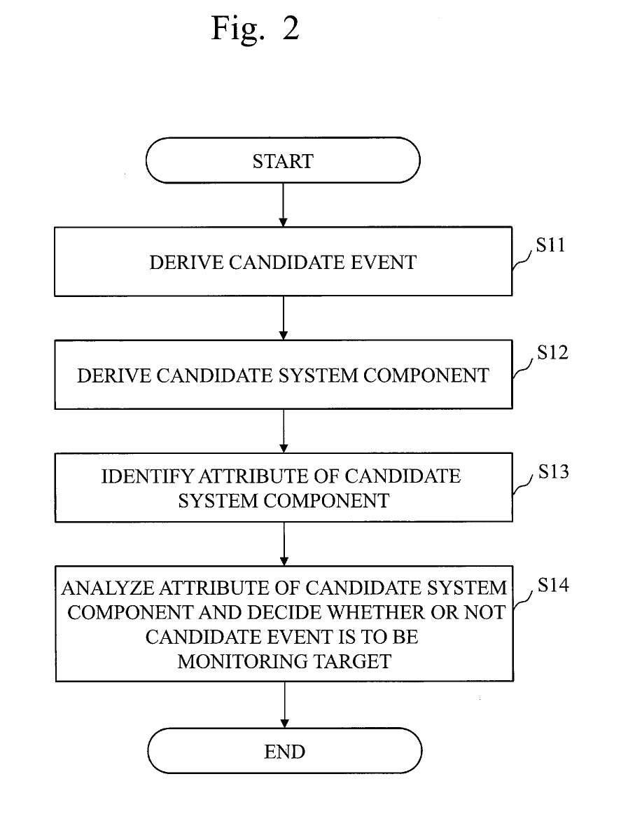

FIG. 2 is a flowchart diagram illustrating the operation example of the information processing apparatus 100.

In the present embodiment, based on the attribute of the candidate system component, it is decided whether or not the candidate system components is to be the monitoring target.

Firstly, in S11, the candidate event derivation unit 101 derives the candidate event.

As described above, for example, when the attack symptom event is notified from the security device in the information system 200, the candidate event derivation unit 101 derives, as the candidate event, the event predicted to occur subsequent to the attack symptom event.

The details of a method for deriving the candidate event by the candidate event derivation unit 101 will be described below.

Note that, S11 is called candidate event derivation process.

Nextly, in S12, the attribute identification unit 102 derives the candidate system component.

Further, in S13, the attribute identification unit 102 identifies the attribute of the candidate system component.

The details of a method for deriving the candidate system component and a method for determining the attribute of the candidate system component will be described below.

Note that, S12 and S13 are called attribute identification processing.

Nextly, in S14, the monitoring target decision unit 103 analyzes the attribute of the candidate system component identified by the attribute identification unit 102 in S13 and decides whether or not the candidate event is to be the monitoring target.

Note that, S14 is called monitoring target decision processing.

The candidate event decided to be the monitoring target becomes, as described above, a target for searching the log in order to analyze the degree of progress of the attack.

On the other hand, the candidate event decided not to be the monitoring target does not become a target for which the log is searched in order to analyze how far the attack progresses.

***Description of Configuration of Attack Event Prediction Apparatus 1***

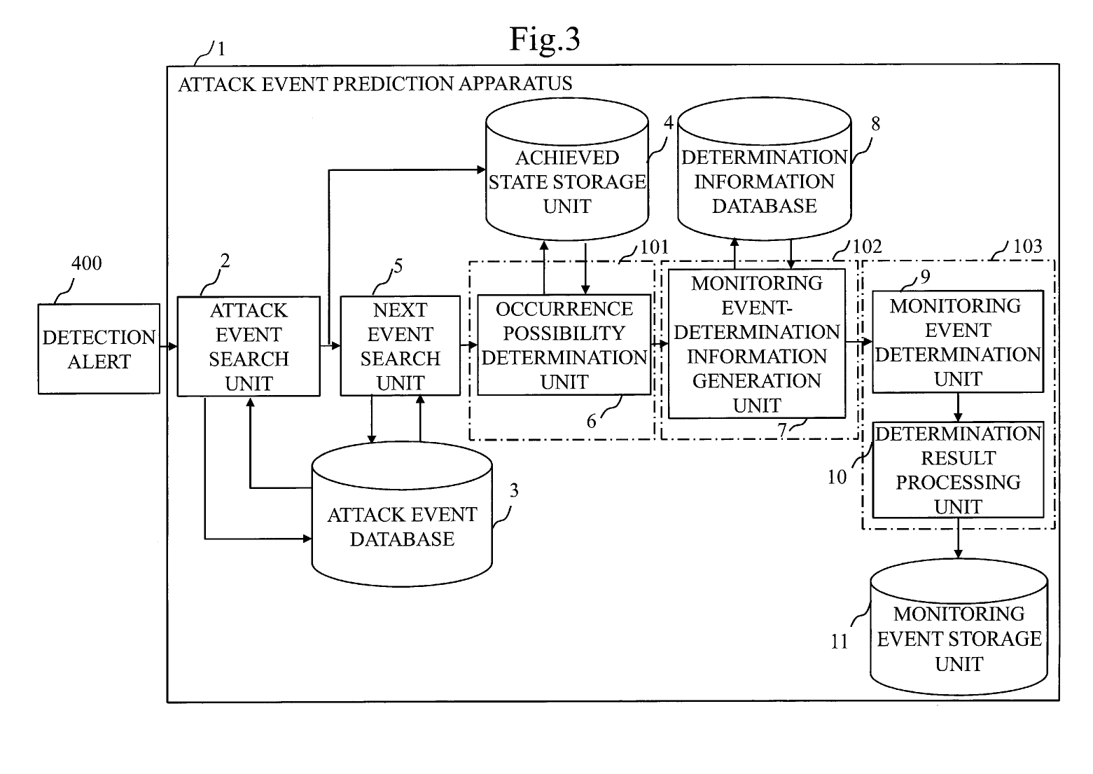

FIG. 3 illustrates a configuration example of an attack event prediction apparatus 1 according to the present embodiment.

The attack event prediction apparatus 1 is an apparatus that is further specified from the information processing apparatus 100 illustrated in FIG. 1.

As illustrated in FIG. 3, the attack event prediction apparatus 1 is configured with an attack event search unit 2, an attack event database 3, an achieved state storage unit 4, a next event search unit 5, an occurrence possibility determination unit 6, a monitoring event-determination information generation unit 7, a determination information database 8, a monitoring event determination unit 9, a determination result processing unit 10, and a monitoring event storage unit 11.

The occurrence possibility determination unit 6 corresponds to the candidate event derivation unit 101 illustrated in FIG. 1.

The monitoring event-determination information generation unit 7 corresponds to the attribute identification unit 102 illustrated in FIG. 1.

The monitoring event determination unit 9 and the determination result processing unit 10 correspond to the monitoring target decision unit 103 illustrated in FIG. 1.

The attack event search unit 2 receives a detection alert 400 from the outside.

Further, the attack event search unit 2 searches the attack event database 3 for attack event definition information corresponding to the detection alert 400.

Further, the attack event search unit 2 writes information obtained from the detection alert 400 in a bound variable of the attack event definition information obtained from the attack event database 3.

The detection alert 400 is a warning message transmitted from various types of devices included in the information system 200, and notifies of the occurrence of the attack symptom event (the attack event).

As an example of the detection alert 400, there is an IDS (Intrusion Detection System) alert.

The detection alert 400 includes a transmission source IP address, a transmission source port number, a transmission destination IP address, and a transmission destination port number of a packet possibly transmitted as a part of the attack on the information system 200; protocols such as a TCP (Transmission Control Protocol) and a UDP (User Datagram Protocol); and information on the detected attack event (a login, a port scan, and the like).

The attack event database 3 accumulates the attack event definition information.

The attack event definition information is information in which the details of the attack event are defined in advance.

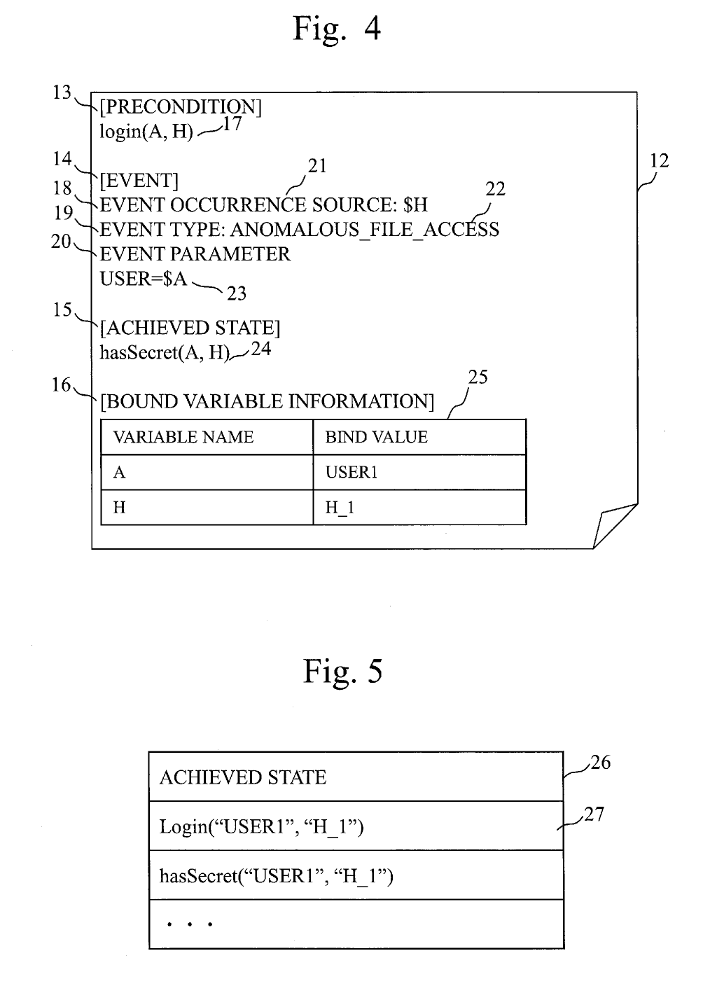

FIG. 4 illustrates an example of the attack event definition information.

As illustrated in FIG. 4, an attack event definition information 12 is configured with a precondition 13, an event 14, an achieved state 15, and a bound variable information 16.

In the precondition 13, a presupposition for the attack event to occur is described in a form of predicate logic.

That is, in the precondition 13, there is described the progress stage (the stage before the event) of the attack before the attack event is observed.

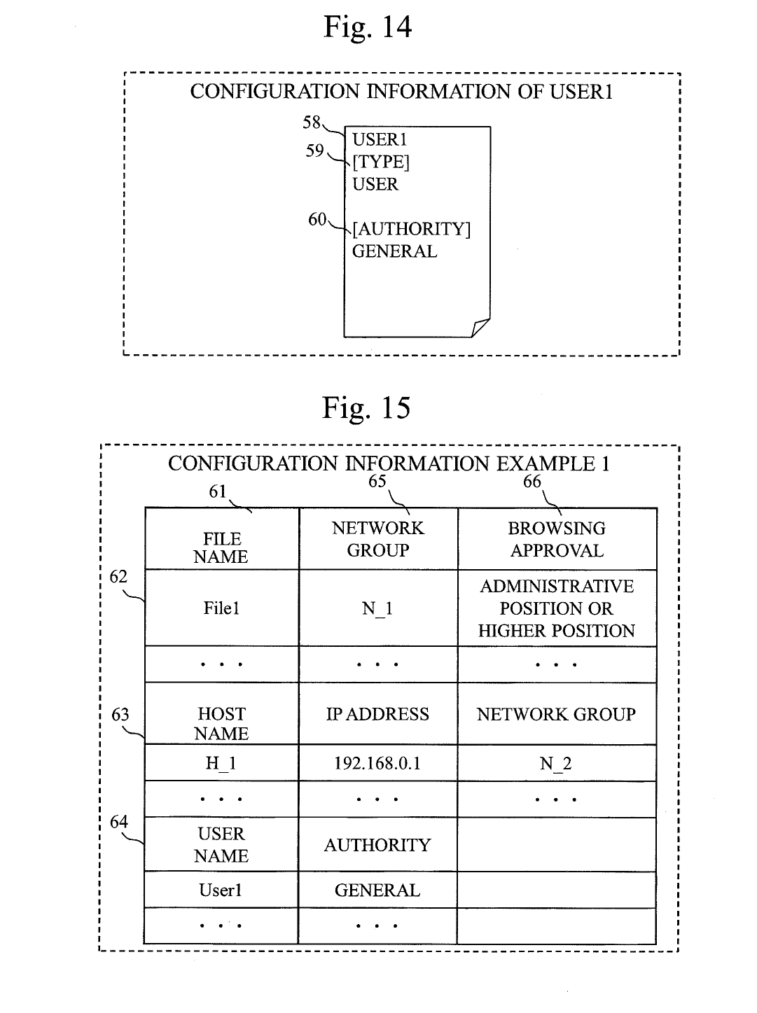

For example, the predicate logic of “login (A, H)” indicated by a reference sign 17 in FIG. 14 represents that, as the precondition for the attack event to occur, a state in which “A is logged in to H” is required.

Note that, “A” and “H” indicated by the reference sign 17 are variables, and specific values and the like obtained from the detection alert 400 are held in columns of the bound variable information 16.

The event 14 represents the attack event observed in the information system 200 during a process in which the attack on the information system 200 is performed.

An event occurrence source 18, an event type 19, and an event parameter 20 are defined for the event 14.

The event occurrence source 18 indicates an event occurrence source being a target of the attack event definition information 12.

A reference sign 21 indicates a value allowed as the occurrence source. In this example, the value is associated with the precondition 17 by the variable H (a dollar sign ($) at a top of “$H” indicates that H is a variable).

The event type 19 specifies a type of the event being a target of the attack event definition information 12.

The event type is concretely specified as a reference sign 22.

The event parameter 20 indicates a parameter of the event.

The event parameter 20 specifies a value being a target of the attack event definition information 12.

In the example illustrated in FIG. 4, a reference sign 23 requires a parameter whose name is USER to hold the same value as the variable A indicated by the reference sign 17.

The achieved state 15 indicates using the predicate logic a state achieved by an attacker when the event occurs that coincides with items of reference signs 18 to 20 of the attack event definition information 12.

That is, in the achieved state 15, there is described the progress stage (the stage after the event) of the attack after the event that coincides with the conditions of the reference signs 18 to 20 is observed.

The achieved state 15 is also called a progress state.

In the example of FIG. 4, “hasSecret (A, H)” of a reference sign 24 indicates a stage at which “a user A acquired secret information of a host H”.

By the detection alert 400, an event occurrence source, an event type, and an event parameter are notified as well as the attack event definition information 12 of FIG. 4.

In the attack event definition information 12 of FIG. 4, values of each variable of the event occurrence source 21 and the event parameter 23 are not identified, but values of each variable of the event occurrence source and the event parameter are identified in the detection alert 400.

The values identified in the detection alert 400 are stored in the columns of the bound variable information 16.

The bound variable information 16 is the columns to store the specific values obtained from the detection alert 400, as a bind value.

For example, in a reference sign 25 of FIG. 4, it is revealed that the variable of “A” is bound by “USER1”.

Further, it is revealed that the variable of “H” is bound by “H_1”.

That is, in the detection alert 400, “USER1” is described as a specific value of the variable “A”, and “H_1” is described as a specific value of the variable “H”.

Note that, the attack event search unit 2 stores the specific values of the variables to the bound variable information 16.

The attack event definition information 12 described above is defined in advance with respect to a plurality of attack events considered to occur in a targeted attack, and the attack event definition information 12 is stored in the attack event database 3 in a searchable state.

Note that, bind values of “USER1” and “H_1” described in the columns of the bound variable information 16 are the system components 300 included in the information system 200.

In the achieved state storage unit 4, achieved state information is stored.

The achieved state information is information in which a state achieved by the attack event is indicated, that is, information in which the progress state of the attack is indicated.

FIG. 5 illustrates an example of the achieved state information.

As illustrated in FIG. 5, an achieved state information 26 stores the predicate logic representing the event that has already been achieved by the attack event.

For example, the predicate logic of “Login (USER1, H_1)” indicated by a reference sign 27 indicates the event in which the user of “USER1” has logged in to the host “H_1”.

The next event search unit 5 searches the attack event database 3 for attack event definition information which includes in a precondition the same predicate logic as the achieved state of the input attack event definition information, and acquires the searched attack event definition information.

As a result of the search, when there are plurality pieces of corresponding attack event definition information, the next event search unit 5 acquires the plurality pieces of attack event definition information.

After acquiring the attack event definition information, the next event search unit 5 stores the bound variable information (the specific values) corresponding to the achieved state of the attack event definition information input from the attack event search unit 2, to bound variable information of the acquired attack event definition information.

Then, the next event search unit 5 outputs the attack event definition information after the specific values are described in the bound variable information, as temporary candidate event definition information representing a candidate for an event that will occur next.

Further, the event defined in the temporary candidate event definition information is called a temporary candidate event.

An event selected by the occurrence possibility determination unit 6 described below, is the candidate event being the monitoring target. The temporary candidate event extracted by the next event search unit 5 is an event having possibility of being selected as the candidate event.

The occurrence possibility determination unit 6 determines whether one or more temporary candidate events input from the next event search unit 5 are currently possible to occur.

Specifically, the occurrence possibility determination unit 6 checks if all of predicate logic described in a precondition of the input temporary candidate event definition information are stored in the achieved state storage unit 4.

When all of predicate logic described in the precondition of the input temporary candidate event definition information are described in the achieved state information of the achieved state storage unit 4, the occurrence possibility determination unit 6 selects, as the candidate event, the temporary candidate event described in the input temporary candidate event definition information.

The occurrence possibility determination unit 6 outputs to the monitoring event-determination information generation unit 7, as the candidate event definition information, the temporary candidate event definition information in which the candidate event is described.

The monitoring event-determination information generation unit 7 acquires the candidate event definition information output from the occurrence possibility determination unit 6.

Then, the monitoring event-determination information generation unit 7 derives, from the bound variable information of the candidate event definition information, the candidate system component being the system component involved in the occurrence of the candidate event.

Furthermore, the monitoring event-determination information generation unit 7 identifies the attribute of the candidate system component.

Specifically, the monitoring event-determination information generation unit 7 identifies the attribute of the candidate system component by referring to determination information of the determination information database 8.

In the determination information, an attribute of the system component is described for each system component.

The monitoring event-determination information generation unit 7 obtains the attribute of the candidate system component from the determination information.

Then, the monitoring event-determination information generation unit 7 notifies the monitoring event determination unit 9 of the attribute of the candidate system component information.

Further, the monitoring event-determination information generation unit 7 outputs to the monitoring event determination unit 9 the candidate event definition information acquired from the occurrence possibility determination unit 6.

The monitoring event determination unit 9 analyzes the attribute of the candidate system component notified by the monitoring event-determination information generation unit 7, and determines whether or not the candidate event is to be the monitoring target.

The monitoring event determination unit 9 outputs to the determination result processing unit 10 a determination result and the candidate event definition information acquired from the monitoring event-determination information generation unit 7.

The determination result processing unit 10 acquires the determination result and the candidate event definition information output from the monitoring event determination unit 9, and performs registration processing or exclusion processing of the candidate event.

Specifically, when the candidate event has been decided by the monitoring event determination unit 9 to be the monitoring target, the determination result processing unit 10 outputs, as monitoring event definition information, the candidate event definition information to the monitoring event storage unit 11.

On the other hand, when the candidate event has been decided by the monitoring event determination unit 9 not to be the monitoring target, the determination result processing unit 10 does not output the candidate event definition information to the monitoring event storage unit 11.

The determination result processing unit 10 may delete the candidate event definition information or save the candidate event definition information to a storage area other than the monitoring event storage unit 11.

Note that, the candidate event decided by the monitoring event determination unit 9 to be the monitoring target is called a monitoring event.

Further, the candidate event definition information in which the details of the monitoring event are described is called the monitoring event definition information.

The monitoring event storage unit 11 stores the monitoring event definition information output from the determination result processing unit 10.

***Description of Operation of Attack Event Prediction Apparatus 1***

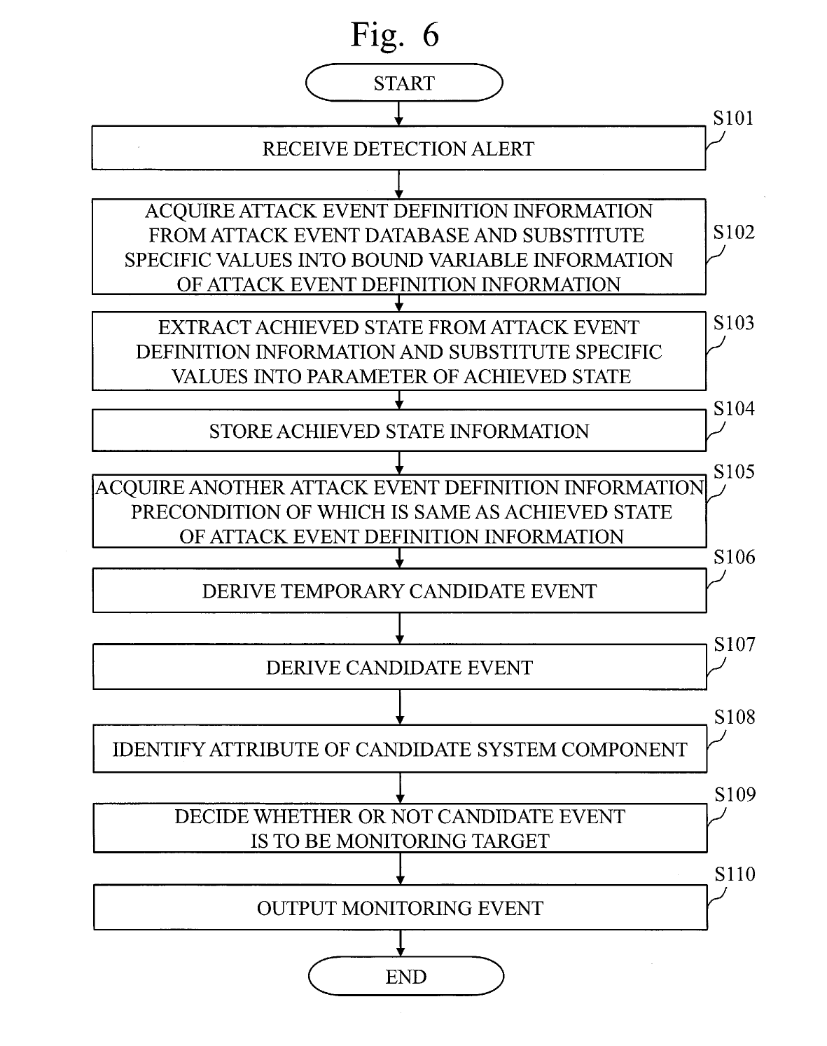

Nextly, an operation of the attack event prediction apparatus 1 according to the first embodiment will be described with reference to FIG. 6.

FIG. 6 is a flowchart illustrating a processing flow of the attack event prediction apparatus 1 according to the first embodiment.

Firstly, in a step S101, the attack event search unit 2 receives the detection alert 400.

The detection alert 400 is, as described above, the warning message transmitted from an device in the information system 200.

Nextly, in a step S102, the attack event search unit 2 accesses to the attack event database 3 and acquires the attack event definition information corresponding to the detection alert 400.

Specifically, the attack event search unit 2 acquires the attack event definition information in which the same event type is described as the event type (for example, ANOMALOUS_FILE_ACCESS) described in the detection alert 400.

Further, the attack event search unit 2 substitutes the specific value of the event occurrence source and the specific value of the event parameter obtained from the detection alert 400 into the bound variable information of the acquired attack event definition information.

The attack event search unit 2 outputs to the next event search unit 5 the attack event definition information in which the specific values are described in the bound variable information.

In a step S103, the attack event search unit 2 reads out from the achieved state storage unit 4 the achieved state information that coincides with the achieved state of the attack event definition information acquired in S102, and replaces the variables in the predicate logic described in the read out achieved state information with the specific values described in the bound variable information.

Then, in a step S104, the attack event search unit 2 stores to the achieved state storage unit 4 the achieved state information after the variables have been replaced with the specific values described in the bound variable information.

In a step S105, the next event search unit 5 searches the attack event database 3 and acquires an attack event definition information which includes a precondition in which the predicate logic is described which is the same as that described in the achieved state of the input attack event definition information.

Nextly, in a step S106, the next event search unit 5 derives the temporary candidate event.

Specifically, the next event search unit 5 substitutes the values used for the achieved state from among the bound variable information of the attack event definition information input from the attack event search unit 2 in S102, into the bound variable information of the attack event definition information obtained in S105.

The next event search unit 5 outputs to the occurrence possibility determination unit 6, as the temporary candidate event definition information, the attack event definition information after the values have been substituted.

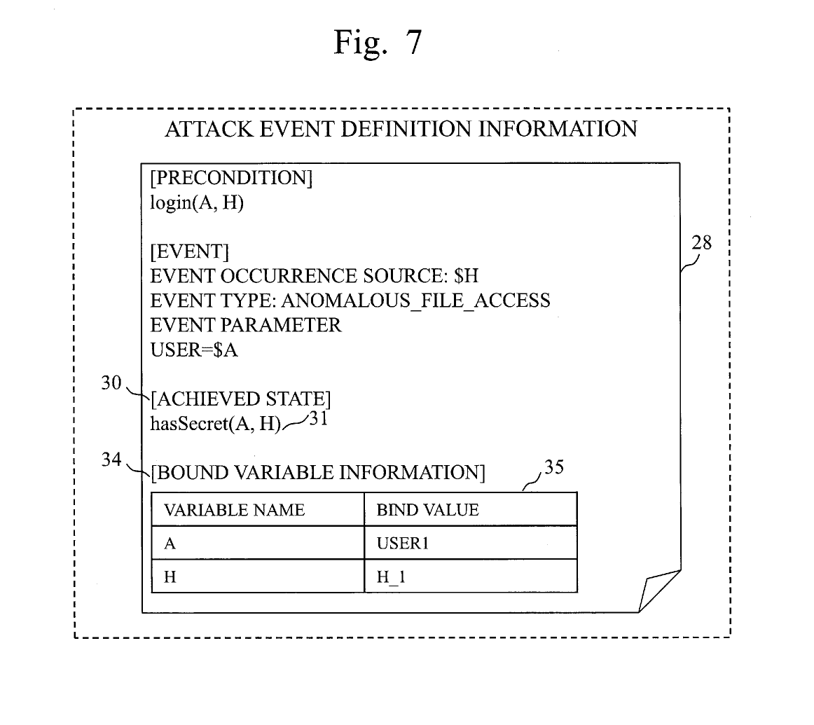

FIG. 7 illustrates an example of an attack event definition information 28.

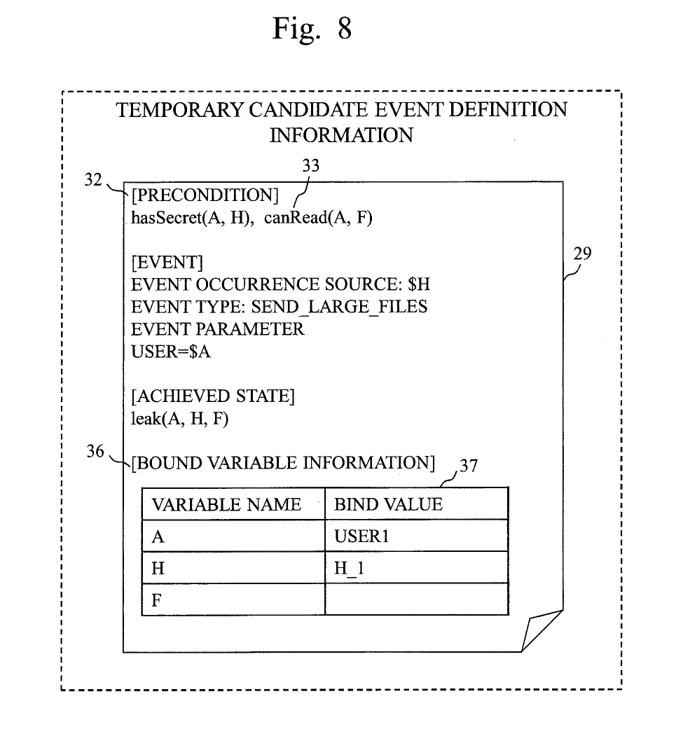

FIG. 8 illustrates an example of a temporary candidate event definition information 29.

The attack event definition information 28 of FIG. 7 is an example of the attack event definition information obtained by the attack event search unit 2 based on the detection alert 400.

The temporary candidate event definition information 29 of FIG. 8 is an example of the temporary candidate event definition information obtained by the next event search unit 5 based on the attack event definition information 28.

That is, in a predicate logic 33 of a precondition 32 in the temporary candidate event definition information 29 of FIG. 8, the same predicate logic is described as a predicate logic 31 of “hasSecret (A, H)” of an achieved state 30 of the attack event definition information of FIG. 7.

Further, specific values of a variable “A” and a variable “H” in the predicate logic 31 of the achieved condition 30 are described as the bind value in a bound variable information 37.

Specifically, the bind value of the variable “A” is “USER1”, and the bind value of the variable “H” is “H_1”.

Nextly, in a step S107, the occurrence possibility determination unit 6 derives the candidate event.

That is, the occurrence possibility determination unit 6 acquires the temporary candidate event definition information 29 and checks if the temporary candidate event indicated in the acquired temporary candidate event definition information 29 is currently possible to occur.

More specifically, the occurrence possibility determination unit 6 inputs to the achieved state storage unit 4 the predicate logic 33 of the precondition 32 and the bound variable information 36 of the temporary candidate event, and searches if there is the achieved state information corresponding to the input predicate logic 33.

At this time, when the bind values of the variables included in the precondition 32 of the temporary candidate event definition information 29 are described in the restrained variable information 36, the occurrence possibility determination unit 6 searches for the achieved state information includes the predicate logic and the bind values which coincide with those of the temporary candidate event definition information 29.

Further, when the bind values are not described in the bound variable information 36 of the temporary candidate event definition information 29, the occurrence possibility determination unit 6 describes, as the bind values, the values described in the achieved state information to the bound variable information 36 of the temporary candidate event definition information 29.

As a result of the search, when all of predicate logics 33 of the precondition 32 of the temporary candidate event definition information 29 are stored in the achieved state storage unit 4, the occurrence possibility determination unit 6 outputs to the monitoring event-determination information generation unit 7 the temporary candidate event definition information 29 as the candidate event definition information.

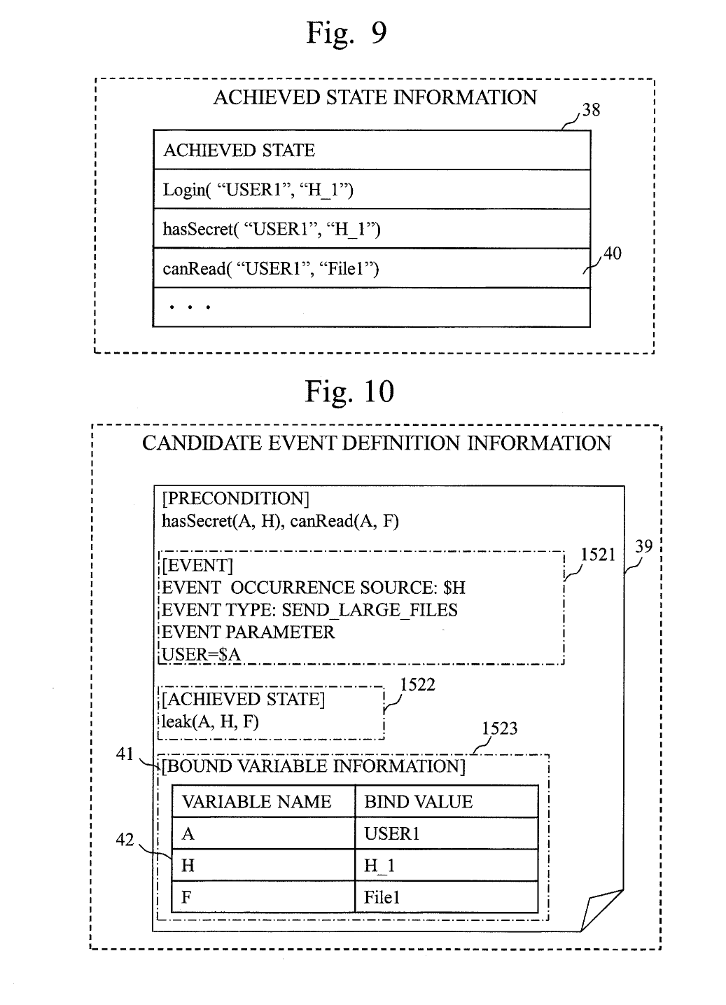

FIG. 9 illustrates an example of an achieved state information held by the achieved state storage unit 4 at the time when the occurrence possibility determination unit 6 operates.

FIG. 10 illustrates an example of a candidate event definition information generated by the occurrence possibility determination unit 6.

The occurrence possibility determination unit 6 checks if in the achieved state storage unit 4 the achieved state information is stored which corresponds to a combination of the predicate logics 33 of “hasSecret (A, H)” and “canRead (A, F)” described in the precondition 32 and the bind values of the bound variable information 36 in the temporary candidate event definition information 29 of FIG. 8.

As for “hasSecret (A, H)”, the achieved state information of “hasSecret (“USER1”, “H_1”)” exists that coincides with the combination of the predicate logic and the bind values.

On the other hand, as for “canRead (A, F)”, the predicate logic coincides but the bind value does not exist. Thus, the occurrence possibility determination unit 6 additionally describes a specific value of “File1” of a predicate logic 40 stored in the achieved state storage unit 4, as the bind value of a variable name of “F” in the bound variable information 36.

A candidate event definition information 39 of FIG. 10 is the candidate event definition information after “File1” has additionally been described as the bind value of the variable name of “F” in a bound variable information 41 as indicated by a reference sign 42.

Note that, “USER1”, “H_1”, and “File1” being the bind values described in the bound variable information 41 of the candidate event definition information 39 of FIG. 10 indicate the system components 300 involved in the occurrence of the candidate event, and correspond to the candidate system components.

In a step S108, the monitoring event-determination information generation unit 7 acquires the candidate event definition information 39 output from the occurrence possibility determination unit 6.

Then, the monitoring event-determination information generation unit 7 extracts, from the bound variable information 41 of the candidate event definition information 39, “USER1”, “H_1”, and “File1” being the candidate system components.

Furthermore, the monitoring event-determination information generation unit 7 identifies the attribute of the candidate system component.

Specifically, the monitoring event-determination information generation unit 7 identifies the attribute of the candidate system component by referring to the determination result of the determination information database 8.

In the determination information, the attribute of the system component is described for each system component.

The monitoring event-determination information generation unit 7 obtains the attribute of the candidate system component from the determination information.

Then, the monitoring event-determination information generation unit 7 notifies the monitoring event determination unit 9 of the attribute of the candidate system component information.

Further, the monitoring event-determination information generation unit 7 outputs to the monitoring event determination unit 9 the candidate event definition information acquired from the occurrence possibility determination unit 6.

In a step S109, the monitoring event determination unit 9 analyzes the attribute of the candidate system component notified by the monitoring event-determination information generation unit 7, and determines whether or not the candidate event is to be the monitoring target.

The monitoring event determination unit 9 outputs to the determination result processing unit 10 the determination result and the candidate event definition information acquired from the monitoring event-determination information generation unit 7.

In a step S110, the determination result processing unit 10 acquires the determination result and the candidate event definition information output from the monitoring event determination unit 9, and performs the registration processing or the exclusion processing of the candidate event.

Specifically, when the candidate event has been decided by the monitoring event determination unit 9 to be the monitoring target, the determination result processing unit 10 outputs, as the monitoring event definition information, the candidate event definition information to the monitoring event storage unit 11.

On the other hand, when the candidate event has been decided by the monitoring event determination unit 9 not to be the monitoring target, the determination result processing unit 10 does not output the candidate event definition information to the monitoring event storage unit 11.

***Description of Advantageous Effects***

As described above, in the present embodiment, it is decided whether or not the candidate event is to be the monitoring target based on the attribute of the system component. The number of the system components is remarkably less than the number of the events.

Therefore, the operation load and the operation time needed for deciding whether or not the candidate event is to be the monitoring target can be reduced and the resource for monitoring the event can be efficiently used.

Further, it is an excessive burden on the system administrator to define in a whitelist a condition for excluding from the monitoring target for each event. However, in accordance with the present embodiment, the load on the system administrator can be reduced by defining the condition using the attribute of the system component.

### Second Embodiment

In the present embodiment, the details of a method for deriving the attribute of the candidate system component and a method for deciding whether or not the candidate event is to be the monitoring target using the attribute of the candidate system component will be described.

Hereinafter, a difference from the first embodiment will mainly be described.

The matters not described below are the same as those in the first embodiment.

***Description of Configuration of Information Processing Apparatus 100***

In the present embodiment, a configuration example of the information processing apparatus 100 is also as illustrated in FIG. 1.

In the present embodiment, the monitoring target decision unit 103 acquires an exclusion rule in which a condition for the event which is to be excluded from the monitoring target is defined using the attribute of the system component.

Further, the monitoring target decision unit 103 compares the attribute of the candidate system component identified by the attribute identification unit 102 with the attribute of the system component defined in the exclusion rule. When the attribute of the candidate system component coincides with the attribute of the system component defined in the exclusion rule, the monitoring target decision unit 103 excludes the candidate event from the monitoring target.

On the other hand, when the attribute of the candidate system component does not coincide with the attribute of the system component defined in the exclusion rule, the monitoring target decision unit 103 decides that the candidate event is to be the monitoring target.

***Description of Configuration of Attack Event Prediction Apparatus 43***

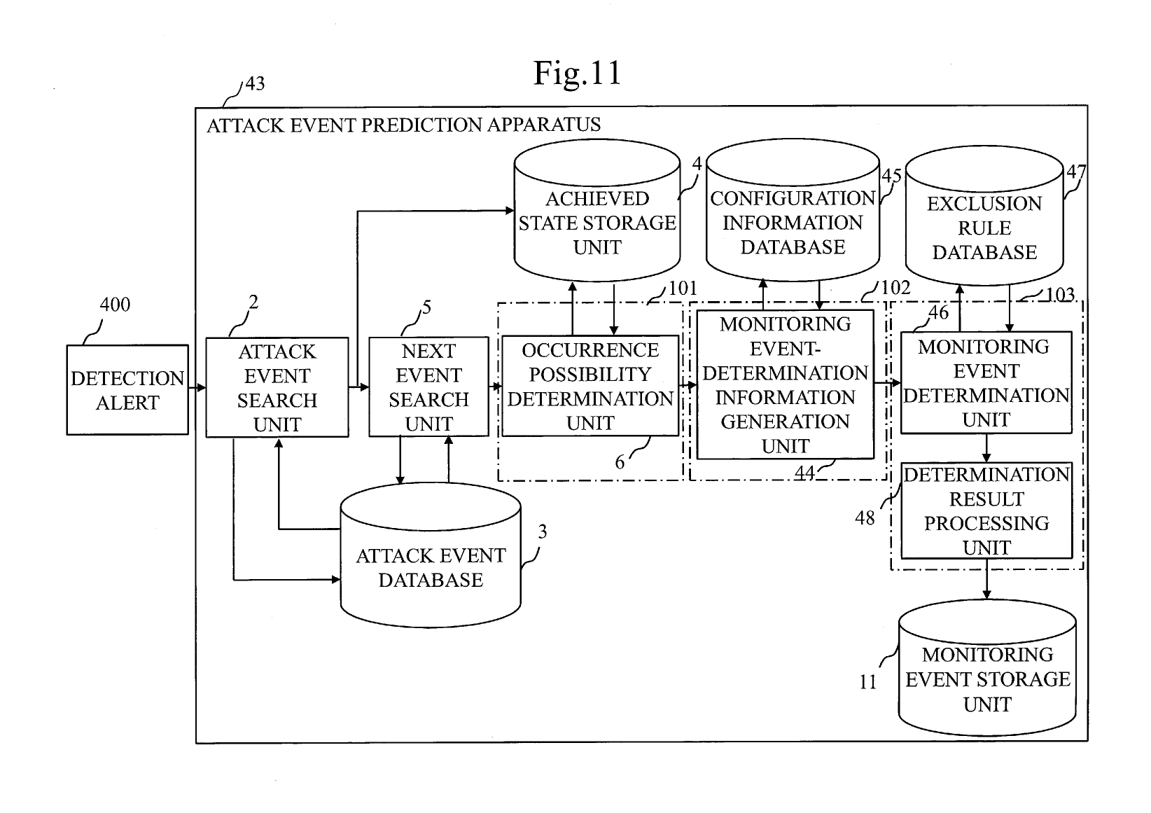

FIG. 11 is a configuration diagram illustrating an attack event prediction apparatus 43 according to the present embodiment.

The attack event prediction apparatus 43 is an apparatus that is further specified from the information processing apparatus 100 according to the present embodiment.

In FIG. 11, the attack event prediction apparatus 43 is configured with the attack event search unit 2, the attack event database 3, the achieved state storage unit 4, the next event search unit 5, the occurrence possibility determination unit 6, a monitoring event-determination information generation unit 44, a configuration information database 45, a monitoring event determination unit 46, an exclusion rule database 47, a determination result processing unit 48, and the monitoring event storage unit 11.

The attack event prediction apparatus 43 identifies, as with the attack event prediction apparatus 1 of the first embodiment, the monitoring event being the monitoring target based on the detection alert 400 obtained from the outside.

However, an internal configuration of the attack event prediction apparatus 43 is different from that of the attack event prediction apparatus 1.

In FIG. 11, the attack event search unit 2, the attack event database 3, the achieved state storage unit 4, the next event search unit 5, the occurrence possibility determination unit 6, and the monitoring event storage unit 11 are the same as the attack event search unit 2, the attack event database 3, the achieved state storage unit 4, the next event search unit 5, the occurrence possibility determination unit 6, and the monitoring event storage unit 11 of the attack event prediction apparatus 1 according to the first embodiment.

Note that, in the present embodiment, the occurrence possibility determination unit 6 corresponds to the candidate event derivation unit 101 illustrated in FIG. 1, the monitoring event-determination information generation unit 44 corresponds to the attribute identification unit 102 illustrated in FIG. 1, and the monitoring event determination unit 46 and the determination result processing unit 48 correspond to the monitoring target decision unit 103 illustrated in FIG. 1.

The monitoring event-determination information generation unit 44 inputs to the configuration information database 45 the bind value in the bound variable information of the candidate event definition information input from the occurrence possibility determination unit 6, and acquires configuration information relating to the bind value.

The configuration information is information indicating the attribute of the candidate system component described in the bind value.

For example, if the bind value is a file, a network group to which the file belongs, restriction relating to browsing approval, and the like are described in the configuration information. If the bind value is a host name, an IP address, a network group, and the like are described in the configuration information. If the bind value is a user, authority information held by the user and the like are described in the configuration information.

The monitoring event-determination information generation unit 44 acquires the configuration information from the configuration information database 45 and obtains the attribute of the candidate system component.

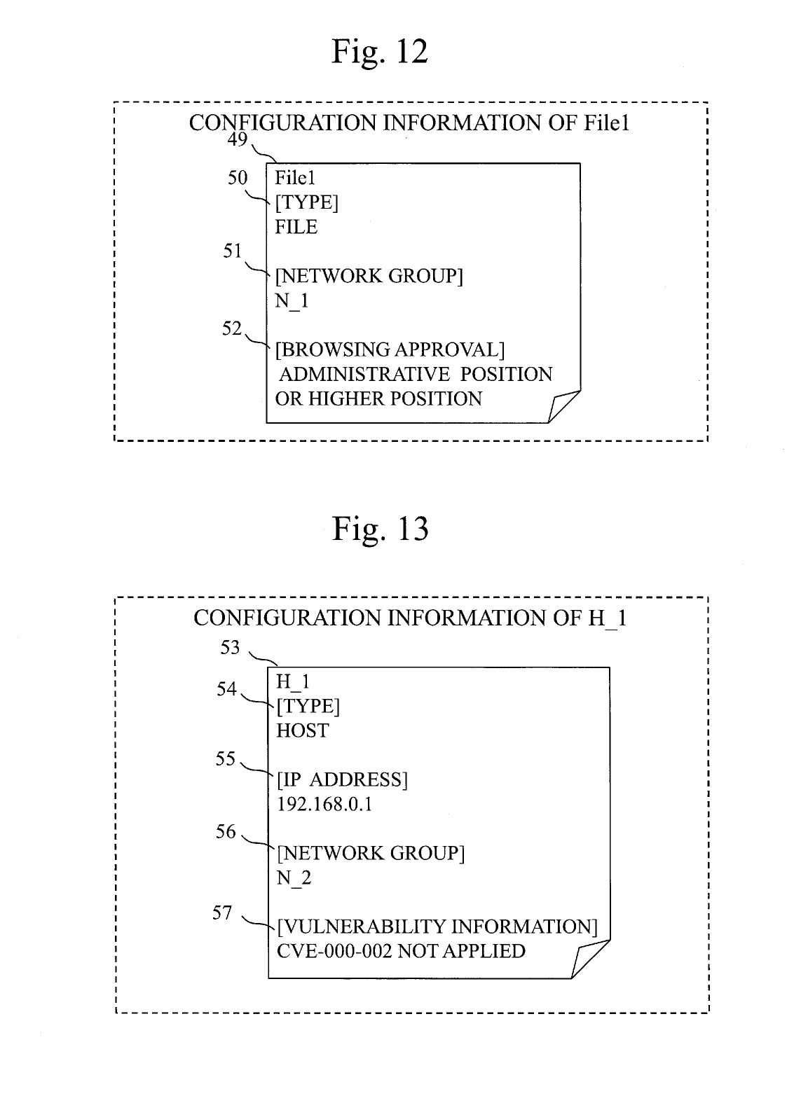

Examples of the configuration information are illustrated in FIGS. 12, 13, and 14.

FIG. 12 illustrates a configuration information 49 relating to the bind value of “File1”.

The configuration information 49 is configured with a type 50, a network group 51, and a browsing approval 52.

The configuration information differs depending on each type.

That is, the configuration information 49 of FIG. 12 is configuration information the type 50 of which is a “file”, a configuration information 53 of FIG. 13 is configuration information a type 54 of which is a “host”, and a configuration information 58 of FIG. 14 is configuration information a type 59 of which is a “user”.

The configuration information 49 of FIG. 12 describes an attribute such as the network group 51 to which the file of “File1” belongs is “N_1” and the browsing approval of the file of “File1” is directed only to “administrative position or higher position”.

The configuration information 53 of the host of “H_1” illustrated in FIG. 13 is configured with the type 54, an IP address 55, a network group 56, and a vulnerability information 57.

The configuration information 53 describes an attribute such as the IP address 55 given to the host of “H_1” is “192.168.0.1”, the network group 56 to which the host of “H_1” belongs is “N_2”, and a counter measure of “CVE-000-002” is not applied to the host of “H_1” as the vulnerability information 57.

The configuration information 58 of the user of “USER1” illustrated in FIG. 14 is configured with the type 59 and an authority 60.

The configuration information 58 describes an attribute such as the authority 60 of the user of “USER1” is “general”.

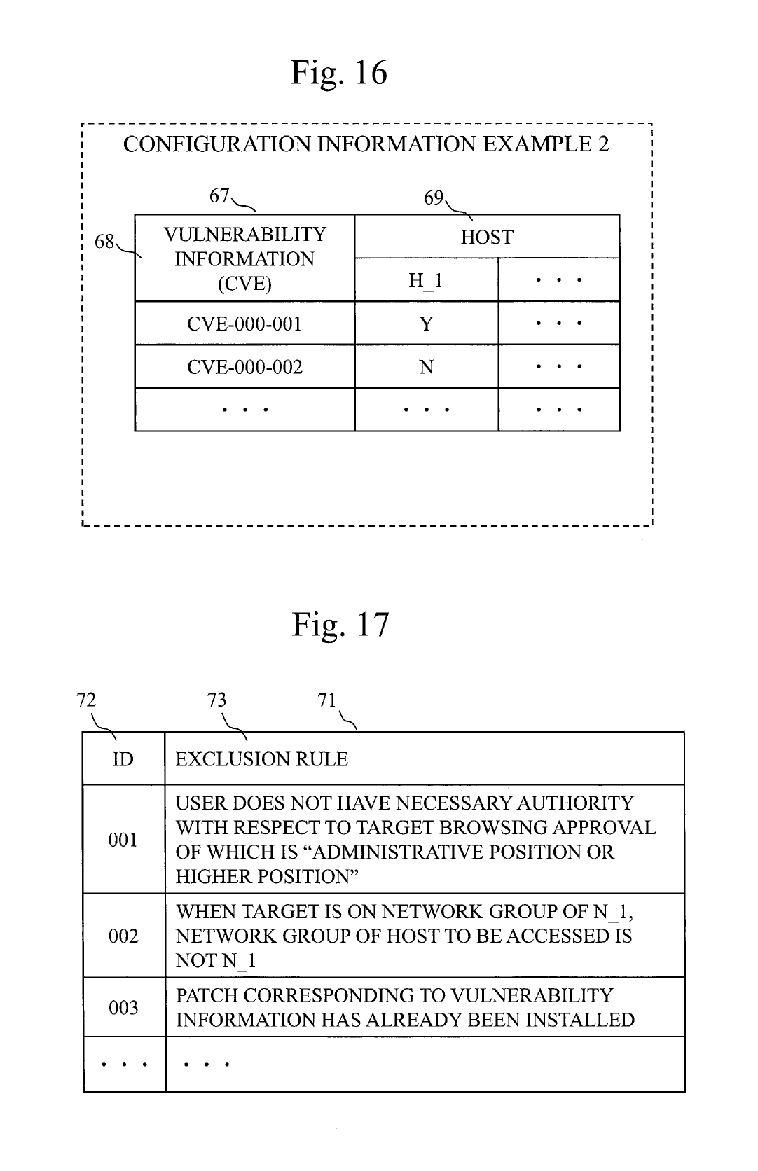

Nextly, examples of the configuration information stored in the configuration information database 45 are illustrated in FIGS. 15 and 16.

In a configuration information 61 of FIG. 15, for each bind value (for example, a file name 62, a host name 63, and a user name 64), the attribute (for example, a network group 65 and a browsing approval 66) of the system component 300 is defined.

The system administrator may manually input the attribute of the system component 300 based on a network configuration and the like. Also, the attribute of the system component 300 may automatically be collected using a tool, and the configuration information 61 may be generated.

Further, in a configuration information 67 of FIG. 16, for each host 69, the presence or absence of an application of a counter measure against a vulnerability information 68 is defined.

Note that, CVE described in FIG. 16 stands for Common Vulnerabilities and Exposures.

in the configuration information 67 of FIG. 16, “Y” represents that the counter measure against vulnerability information of CVE-000-001 has been applied to the host of “H_1”.

On the other hand, “N” represents that the counter measure against vulnerability information of CVE-000-002 has not been applied to the host of “H_1”.

As just described, the attribute of the system component 300 is defined in the configuration information 61 and the configuration information 67.

A plurality of databases may exist such as a configuration information database accumulating the configuration information 61 and a configuration information database accumulating the configuration information 67.

The monitoring event determination unit 46 acquires the exclusion rule from the exclusion rule database 47 with the configuration information from the monitoring event-determination information generation unit 44 as an input, checks if the attribute indicated in the input configuration information corresponds to the exclusion rule, and determines whether or not the candidate event is to be the monitoring target.

Then, the monitoring event determination unit 46 outputs the determination result to the determination result processing unit 48.

An example of an exclusion rule list held by the exclusion rule database 47 is illustrated in FIG. 17.

In an exclusion rule list 71, an exclusion rule 73 is described for each ID 72.

In the exclusion rule list 71 of FIG. 17, the exclusion rule 73 is written in a sentence, but it may be written in any type of form if the rule can be compared with the configuration information.

For example, the exclusion rule 73 may be written in the predicate logic.

The determination result processing unit 48 obtains as an input the candidate event definition information output from the occurrence possibility determination unit 6 and the determination result of the monitoring event determination unit 46.

The determination result processing unit 48 performs processing to exclude the candidate event determined by the monitoring event determination unit 46 that monitoring is not needed.

Further, the determination result processing unit 48 outputs to the monitoring event storage unit 11, as the monitoring event definition information, the candidate event definition information determined by the monitoring event determination unit 46 to be the monitoring target.

***Description of Operation of Attack Event Prediction Apparatus 43***

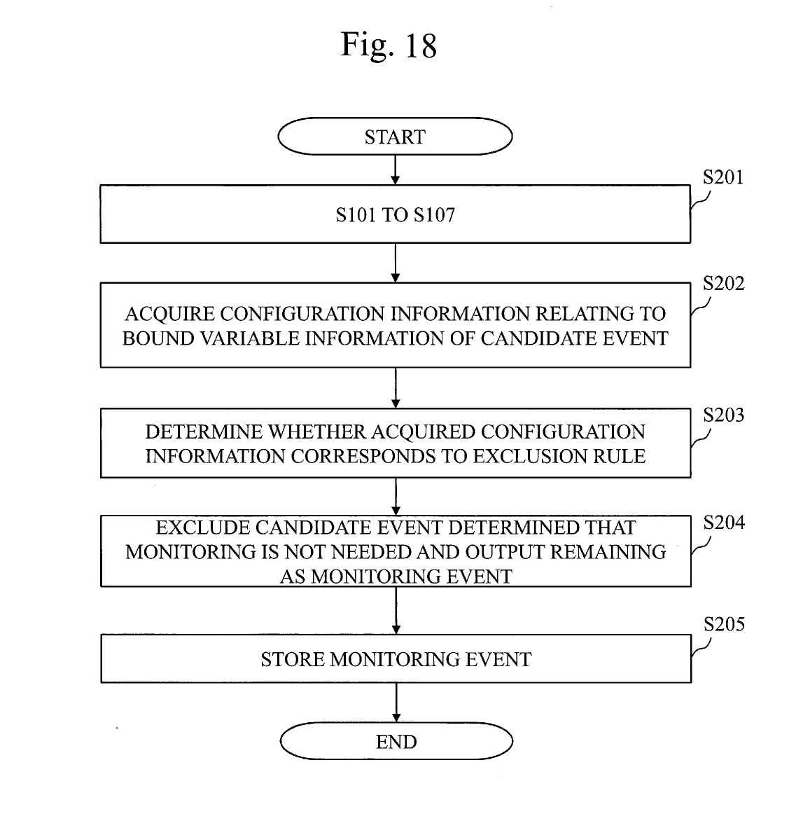

Nextly, an operation of the attack event prediction apparatus 43 according to the second embodiment will be described with reference to FIG. 18.

FIG. 18 is a flowchart illustrating an entire processing flow of the attack event prediction apparatus 43 according to the second embodiment.

Firstly, in a step S201, the same processing as S101 to S107 is performed.

Nextly, in a step S202, the monitoring event-determination information generation unit 44 outputs to the configuration information database 45 the bind value of the bound variable information of the input candidate event definition information, and acquires the configuration information relating to the bound variable information.

That is, the monitoring event-determination information generation unit 44 acquires the configuration information in which the attribute of the candidate system component is indicated, and determines the attribute of the candidate system component.

Nextly, the monitoring event-determination information generation unit 44 outputs to the monitoring event determination unit 46 the configuration information acquired from the configuration information database 45.

In a step S203, the monitoring event determination unit 46 acquires the exclusion rule list from the exclusion rule database 47, and determines whether the attribute of the configuration information input to the monitoring event determination unit 46 in S202 corresponds to any of exclusion rules described in the exclusion rule list.

As described above, when the attribute of the candidate system component coincides with the attribute of the system component defined in the exclusion rule, the monitoring event determination unit 46 determines that the candidate event does not need to be monitored.

On the other hand, when the attribute of the candidate system component does not coincide with the attribute of the system component defined in the exclusion rule, the monitoring event determination unit 46 determines that the candidate event is to be the monitoring target.

The monitoring event determination unit 46 outputs the determination result to the determination result processing unit 48.

In a step S204, the determination result processing unit 48 excludes the candidate event definition information determined by the monitoring event determination unit 46 that monitoring is not needed.

Further, the determination result processing unit 48 outputs to the monitoring event storage unit 11, as the monitoring event definition information, the candidate event definition information determined by the monitoring event determination unit 46 to be the monitoring target.

In a step S205, the monitoring event storage unit 11 stores the monitoring event definition information output from the determination result processing unit 48.

The operation of the attack event prediction apparatus 43 according to the present embodiment has been described above.

Hereinafter, the details of processing for determining, using the configuration information, the candidate event that does not need to be monitored will be described.

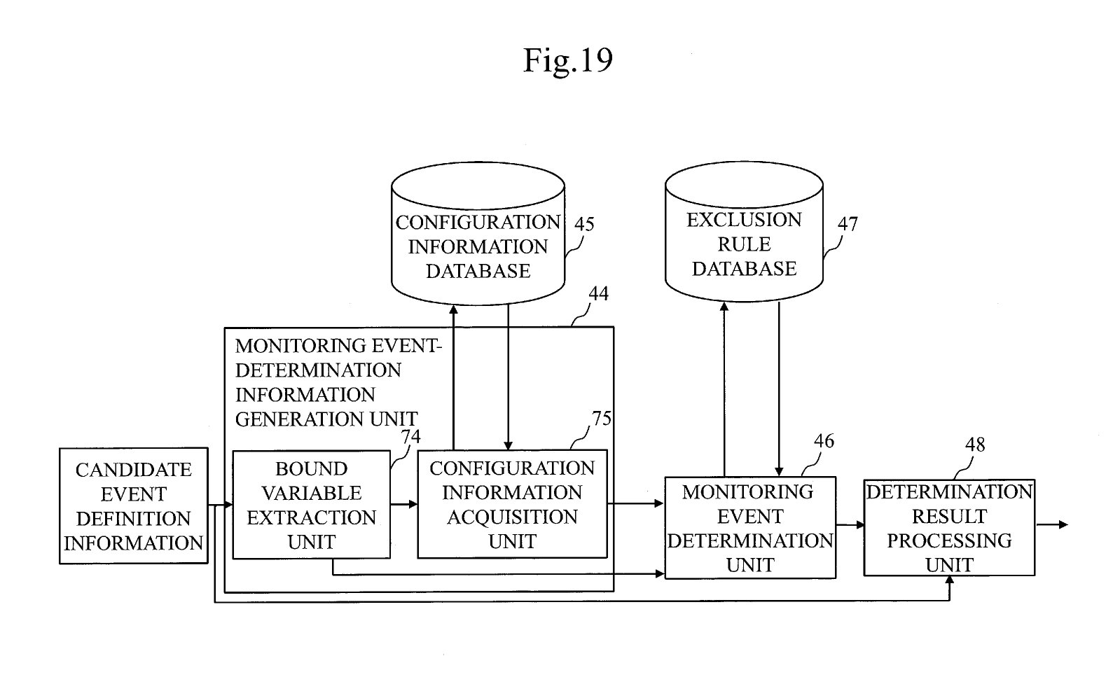

FIG. 19 illustrates a function for determining the candidate event that does not need to be monitored in the attack event prediction apparatus 43.

The function for determining the candidate event that does not need to be monitored is configured with the monitoring event-determination information generation unit 44, the configuration information database 45, the monitoring event determination unit 46, the exclusion rule database 47, and the determination result processing unit 48.

Further, the monitoring event-determination information generation unit 44 is configured with a bound variable extraction unit 74 and a configuration information acquisition unit 75.

The bound variable extraction unit 74 extracts the bind value of the bound variable information from the input candidate event definition information.

The configuration information acquisition unit 75 acquires from the configuration information database 45 the configuration information relating to the bind value with the bind value extracted by the bound variable extraction unit 74 as the input, and outputs the acquired configuration information to the monitoring event determination unit 46.

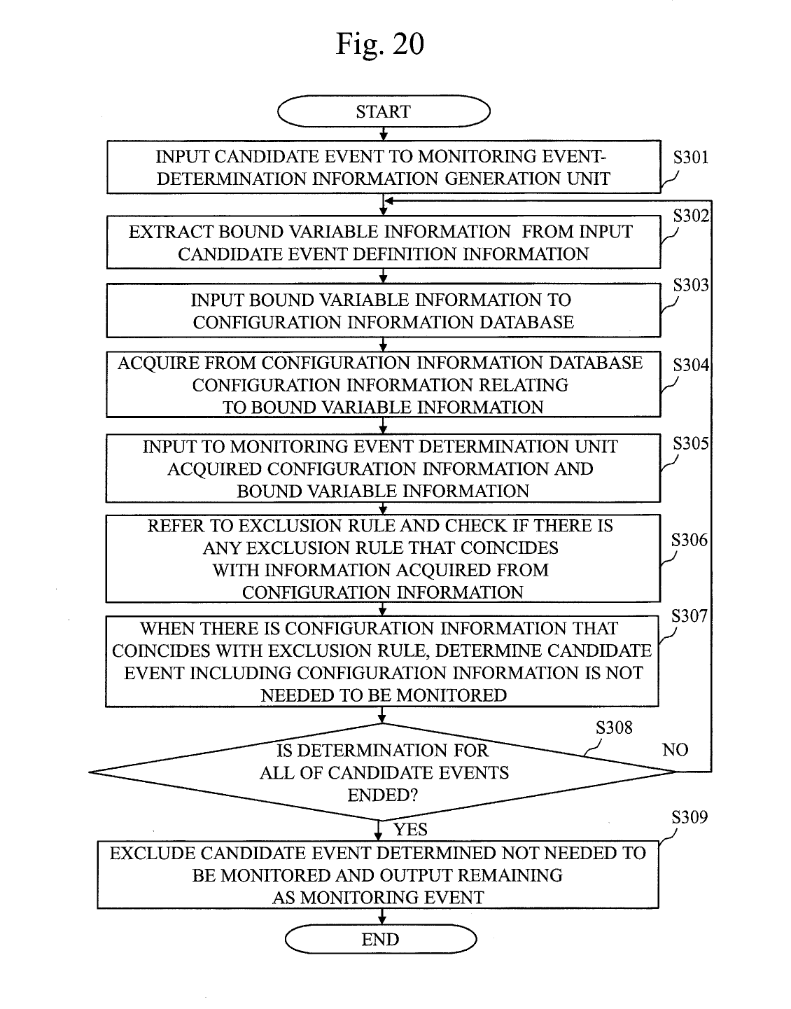

Nextly, an operation for determining the candidate event that does not need to be monitored will be described with reference to FIG. 20.

Firstly, in a step S301, the candidate event definition information is input to the monitoring event-determination information generation unit 44.

Nextly, in a step S302, the bound variable extraction unit 74 in the monitoring event-determination information generation unit 44 extracts the bind value of the bound variable information from the input candidate event definition information.

Assume a case where the candidate event definition information 39 of FIG. 10 is input to the monitoring event-determination information generation unit 44.

The bound variable extraction unit 74 extracts bind values of “USER1”, “H_1”, and “File1” from the candidate event definition information 39.

In a step S303, the bind values extracted in S302 is input to the configuration information acquisition unit 75, and the configuration information acquisition unit 75 inputs the bind values to the configuration information database 45.

That is, the configuration information acquisition unit 75 inputs the bind values of “USER1”, “H_1”, and “File1” to the configuration information database 45.

In a step S304, the configuration information acquisition unit 75 acquires the configuration information relating to the bind values input in S303 to the configuration information database 45.

For example, the configuration information acquisition unit 75 acquires the configuration information 49 of FIG. 12, the configuration information 53 of FIG. 13, and the configuration information 58 of FIG. 14.

In a step S305, the configuration information acquired in S304 and the bound variable information are input to the monitoring event determination unit 46.

In a step S306, the monitoring event determination unit 46 acquires the exclusion rule list from the exclusion rule database 47, and checks if there is any configuration information that corresponds to the exclusion rule from among the configuration information relating to the bind values included in the bound variable information input to the monitoring event determination unit 46.

For example, with respect to the configuration information 49 of FIG. 12, the configuration information 53 of FIG. 13, and the configuration information 58 of FIG. 14, the monitoring event determination unit 46 acquires the exclusion rule list 71 of FIG. 17.

In the configuration information 49 of FIG. 12, the browsing approval 52 of File1 is “administrative position or higher position”, and in the configuration information 58 of FIG. 14, the authority 60 of USER1 is “general”.

Therefore, the monitoring event determination unit 46 evaluates from the exclusion rule list 71 that the configuration information corresponds to the exclusion rule of “user does not have necessary authority with respect to target browsing approval of which is “administrative position or higher position”” associated with ID: 001.

In a step S307, as a result of checking in S306, when there is the configuration information that coincides with the exclusion rule, the monitoring event determination unit 46 determines that it is not necessary to monitor the candidate event whose bound variable information includes the attribute described in the corresponding configuration information.

In a step S308, it is evaluated whether processing from the step S302 to the step S307 for all of candidate events has been completed.

When the processing from the step S302 to the step S307 has been completed for all of the candidate events, a step S309 is performed.

When the processing from the step S302 to the step S307 has not been completed for any of the candidate events, the processing from the step S302 to the step S307 is performed to an unprocessed candidate event.

In a step S309, the candidate event definition information and all of determination results obtained until the step S308 are input to the determination result processing unit 48. The determination result processing unit 48 excludes the candidate event definition information determined that monitoring is not needed, and outputs to the monitoring event storage unit 11 remaining candidate event definition information as the monitoring event definition information.

***Description of Advantageous Effects***

As described above, in the present embodiment, the configuration information is acquired from the bound variable information of the candidate event. The candidate event that does not need to be monitored can be identified, based on the acquired configuration information, by comparing with the predetermined exclusion rule.

In the configuration information, the attribute of the system component is described. Further, in the exclusion rule, a condition of the event that does not need to be monitored is described using the attribute of the system component.

Therefore, as with the first embodiment, it is decided whether or not the candidate event is to be the monitoring target based on the attribute of the system component. The number of the system components is remarkably less than the number of the events.

Therefore, the operation load and the operation time needed for deciding whether or not the candidate event is to be the monitoring target can be reduced. Further, the load on the system administrator can be reduced.

### Third Embodiment

In the present embodiment, for example, when the exclusion rule is invalidated by updating vulnerability information, network information, and the like, an example will be described, where the candidate event having been excluded from the monitoring target by the invalidated exclusion rule is set to be the monitoring target.

Hereinafter, a difference from the second embodiment will mainly be described.

The matters not described below are the same as those in the second embodiment.

***Description of Configuration of Information Processing Apparatus 100***

In the present embodiment, a configuration example of the information processing apparatus 100 is also as illustrated in FIG. 1.

In the present embodiment, when the exclusion rule is invalidated after excluding the candidate event from the monitoring target, the monitoring target decision unit 103 sets the candidate event to be the monitoring target.

***Description of Configuration of Attack Event Prediction Apparatus 76***

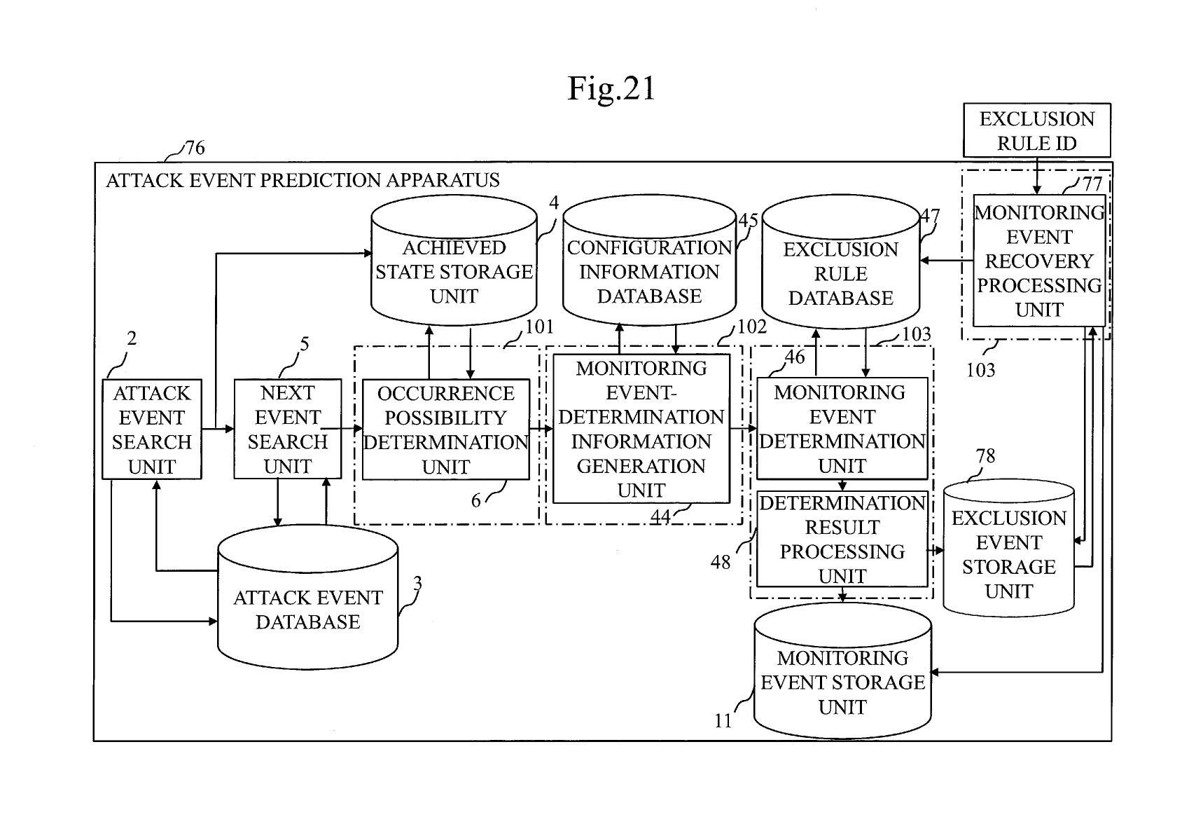

FIG. 21 illustrate a configuration diagram of an attack event prediction apparatus 76 according to the present embodiment.

The attack event prediction apparatus 76 is an apparatus that is further specified from the information processing apparatus 100 according to the present embodiment.

As illustrated in FIG. 21, the attack event prediction apparatus 76 is configured with the attack event search unit 2, the attack event database 3, the achieved state storage unit 4, the next event search unit 5, the occurrence possibility determination unit 6, the monitoring event-determination information generation unit 44, the configuration information database 45, the monitoring event determination unit 46, the exclusion rule database 47, the determination result processing unit 48, a monitoring event recovery processing unit 77, an exclusion event storage unit 78, and the monitoring event storage unit 11.

The attack event prediction apparatus 76 identifies, as with the attack event prediction apparatus 43 of the second embodiment, the monitoring event being the monitoring target based on the detection alert 400 obtained from the outside.

However, in FIG. 21, in comparison with FIG. 11, the monitoring event recovery processing unit 77 and the exclusion event storage unit 78 are added.

In FIG. 21, the attack event search unit 2, the attack event database 3, the achieved state storage unit 4, the next event search unit 5, the occurrence possibility determination unit 6, and the monitoring event storage unit 11 are the same as the attack event search unit 2, the attack event database 3, the achieved state storage unit 4, the next event search unit 5, the occurrence possibility determination unit 6, and the monitoring event storage unit 11 of the attack event prediction apparatus 1 of the first embodiment.

Further, the configuration information database 45, the monitoring event determination unit 46, the exclusion rule database 47, and the determination result processing unit 48 are the same as the configuration information database 45, the monitoring event determination unit 46, the exclusion rule database 47, and the determination result processing unit 48 of the attack event prediction apparatus 43 of the second embodiment.

Note that, in the present embodiment, the occurrence possibility determination unit 6 corresponds to the candidate event derivation unit 101 illustrated in FIG. 1, the monitoring event-determination information generation unit 44 corresponds to the attribute identification unit 102 illustrated in FIG. 1, and the monitoring event determination unit 46, the determination result processing unit 48, and the monitoring event recovery processing unit 77 correspond to the monitoring target decision unit 103 illustrated in FIG. 1.

The monitoring event recovery processing unit 77 acquires an ID of the exclusion rule to be invalidated.

Further, the monitoring event recovery processing unit 77 requires the exclusion rule database 47 to invalidate the exclusion rule corresponding to the acquired ID.

Further, the monitoring event recovery processing unit 77 extracts, from among the candidate event definition information of the candidate event excluded from the monitoring target and stored in the exclusion event storage unit 78, the candidate event definition information of the candidate event excluded from the monitoring target in accordance with the exclusion rule corresponding to the acquired ID.

Then, the monitoring event recovery processing unit 77 stores the extracted candidate event definition information to the monitoring event storage unit 11.

The exclusion event storage unit 78 stores the candidate event definition information excluded from the monitoring target by the determination result processing unit 48.

Note that, in FIG. 21, an illustration of the detection alert 400 is omitted for drawing reasons. However, in the present embodiment, the attack event search unit 2 also receives the detection alert 400.

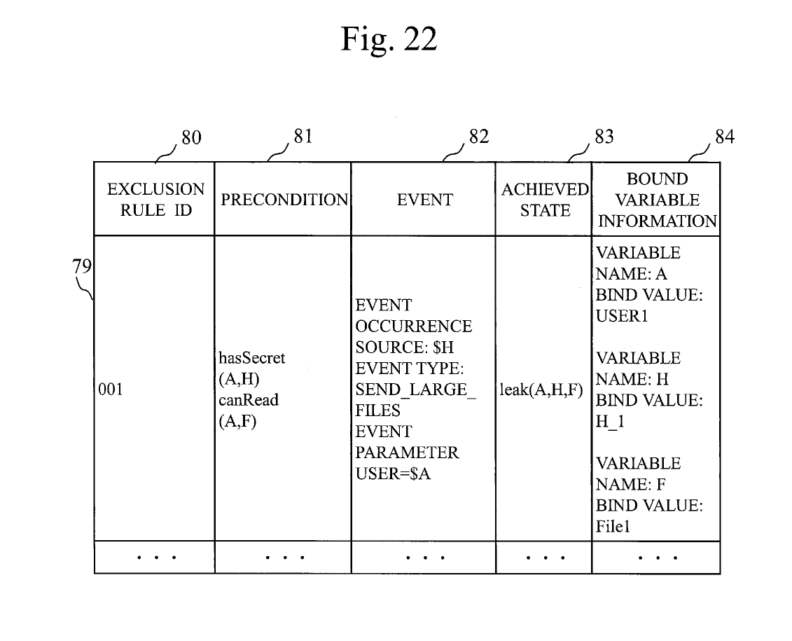

FIG. 22 illustrates an example of the stored contents of the exclusion event storage unit 78.

The exclusion event storage unit 78 stores an exclusion event information table.

The exclusion event information table is configured with an exclusion rule ID 80, a precondition 81, an event 82, an achieved state 83, and a bound variable information 84.

The exclusion rule ID 80 is an ID of the exclusion rule used for the determination for excluding the candidate event from the monitoring target.

The precondition 81, the event 82, the achieved state 83, and the bound variable information 84 are information described in the candidate event definition information.

FIG. 22 illustrates, as an example, the exclusion event information table in a case where the candidate event of FIG. 10 is excluded from the monitoring target.

***Description of Operation of Attack Event Prediction Apparatus 76***

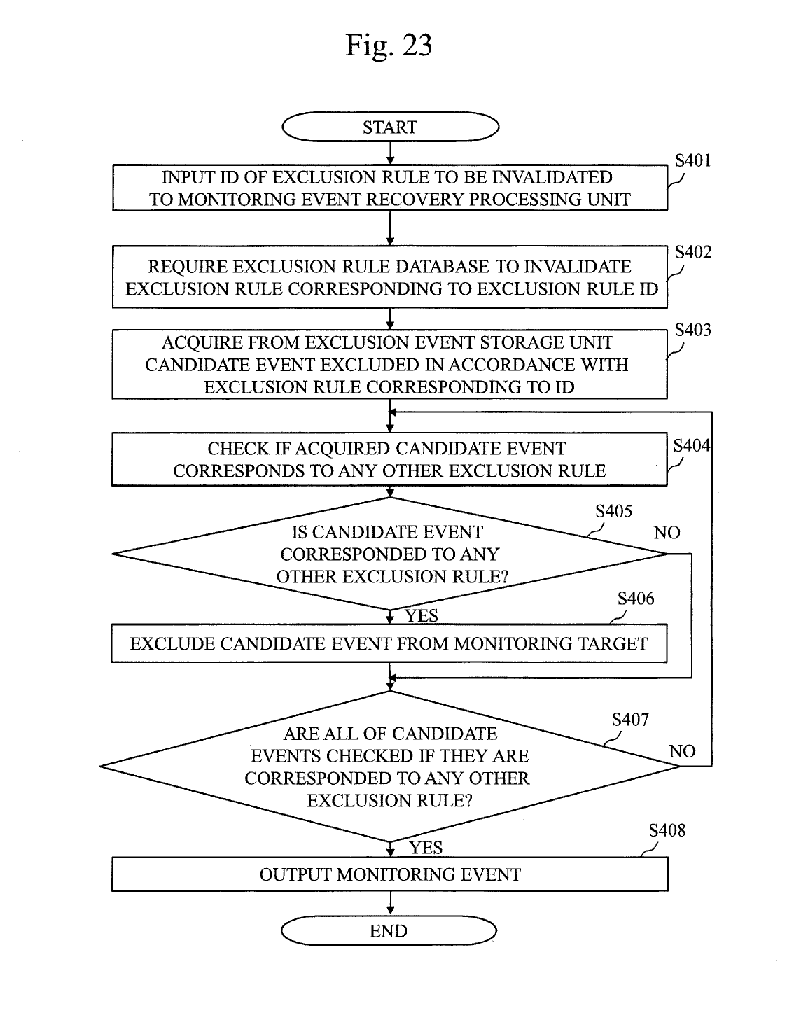

Nextly, an operation of the attack event prediction apparatus 76 according to the third embodiment will be described with reference to FIG. 23.

FIG. 23 is a flowchart of illustrating an entire processing flow of the attack event prediction apparatus 76 according to the third embodiment.

Firstly, in a step S401, a user of the attack event prediction apparatus 76 inputs to the monitoring event recovery processing unit 77 the ID of the exclusion rule to be invalidated.

In a step S402, the monitoring event recovery processing unit 77 requires the exclusion rule database 47 to invalidate the exclusion rule corresponding to the acquired ID.

The exclusion rule database 47 which has received a request for invalidation invalidates the exclusion rule corresponding to the ID.

The invalidated exclusion rule is not used for a determination of the monitoring event determination unit 46.

In a step S403, the monitoring event recovery processing unit 77 acquires from the exclusion event storage unit 78 an entry of the exclusion event information table corresponding to the ID input in the step S401.

The exclusion event storage unit 78 deletes the entry transferred to the monitoring event recovery processing unit 77 from the exclusion event information table.

In a step S404, the monitoring event recovery processing unit 77 checks, by searching the exclusion event storage unit 78, if the candidate event indicated in the entry acquired from the exclusion event storage unit 78 corresponds to any other exclusion rule.

That is, the monitoring event recovery processing unit 77 checks if the candidate event indicated in the column of the event 82 indicated in the entry acquired in the step S403 is described in any other entry of the exclusion event information table.

When the candidate event corresponds to any other exclusion rule and is decided not to be the monitoring target, there exists an entry in which the candidate event is described in addition to the entry acquired in S403.

In a step S405, after processing S404, the processing branches depending on whether there exists any other entry in which the candidate event is described.

When any other entry does not exist, the monitoring event recovery processing unit 77 performs the processing of S407.

When any other entry exists, the monitoring event recovery processing unit 77 performs the processing of S406.

In a step S406, the monitoring event recovery processing unit 77 excludes the candidate event from the monitoring target.

In a step S407, if there is a plurality of candidate events acquired in the processing of S403, it is evaluated for all of the candidate events whether or not each candidate event has been checked as to whether or not to correspond to any other exclusion rule.

When there is an unchecked candidate event, the monitoring event recovery processing unit 77 repeats the processing from the step S404 toward the unchecked candidate event.

When the check on the all of the candidate events is completed, the monitoring event recovery processing unit 77 outputs to the monitoring event storage unit 11 the candidate event as the monitoring event.

***Description of Advantageous Effects***

As just described, in the present embodiment, the candidate event that has once been decided not to be the monitoring target is newly specified as the candidate event. Thus, it is possible to deal flexibly with such a case where monitoring of the candidate event that has once been decided not to be the monitoring target is needed is updated so that the vulnerability information, the network information, or the like.

### Fourth Embodiment

In the first to third embodiments, examples have been described in which the monitoring event storage unit 11 stores only the candidate event definition information selected as the monitoring target.

In the present embodiment, an example will be described in which all of monitoring event definition information is stored in the monitoring event storage unit 11, and depending on the progress state of the attack on the information system 200, the monitoring event definition information stored in the monitoring event storage unit 11 is excluded from the monitoring target.

Hereinafter, a difference from the first embodiment will mainly be described.

The matters not described below are the same as those in the first embodiment.

***Description of Configuration of Information Processing Apparatus 150***

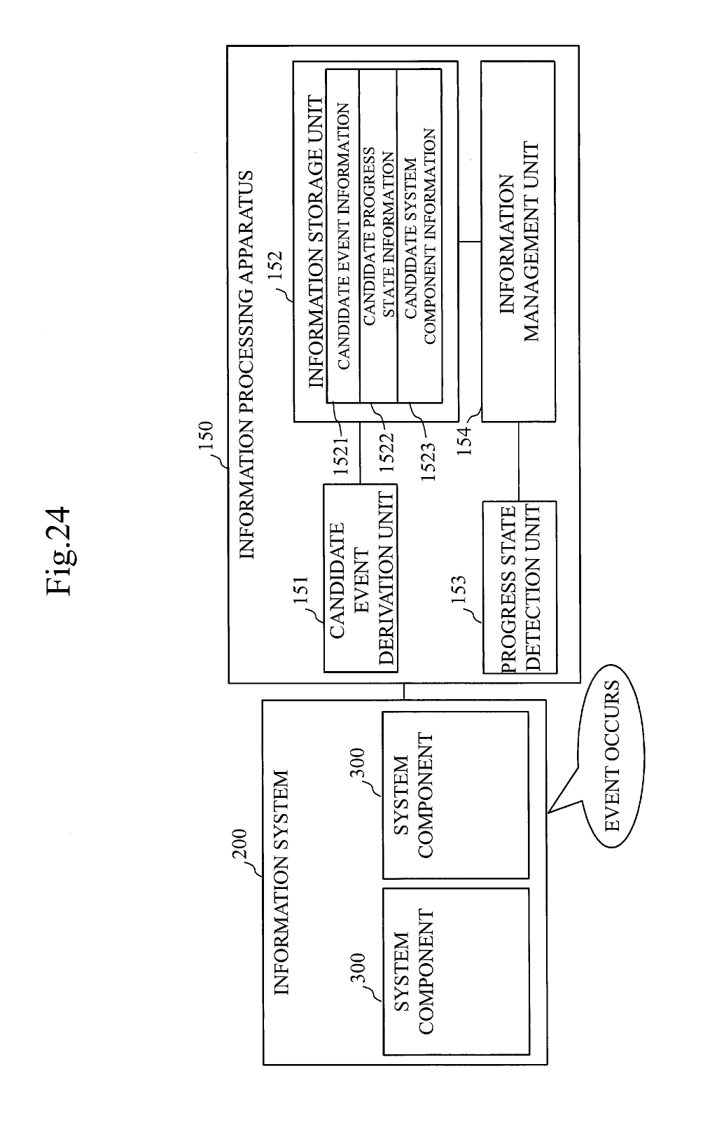

FIG. 24 illustrates a configuration example of an information processing apparatus 150 and the information system 200 according to the present embodiment.

The information system 200 is the same as the one illustrated in FIG. 1 and includes the plurality of system components 300.

Note that, the descriptions of the information system 200 and the system component 300 are omitted.

In the information processing apparatus 150, when the information system 200 is attacked, a candidate event derivation unit 151 derives, as the candidate event, the event predicted to occur in the information system 200.

More specifically, when the attack symptom event being the symptom of the attack on the information system 200 occurs, the candidate event derivation unit 151 derives, as the candidate event, the event predicted to occur in the information system 200 subsequent to the attack symptom event.

Further, the candidate event derivation unit 151 derives a candidate progress state being the progress state of the attack on the information system 200 when the candidate event occurs.

Further, the candidate event derivation unit 151 derives, as the candidate system component, the system component involved in the occurrence of the candidate event from among the plurality of system components 300.

An information storage unit 152 stores a candidate event information 1521 in which the contents of the candidate event are indicated and a candidate progress state information 1522 in which the candidate progress state is indicated.

Further, the information storage unit 152 stores a candidate system component information 1523 in which the candidate system component is indicated.

Specifically, the candidate event information 1521 is information located in an area enclosed by a dashed line of a reference sign 1521 indicated in FIG. 10.

Specifically, the candidate progress state information 1522 is information located in an area enclosed by a dashed line of a reference sign 1522 indicated in FIG. 10.

Specifically, the candidate system component information 1523 is information located in an area enclosed by a dashed line of a reference sign 1523 indicated in FIG. 10.

A progress state detection unit 153 detects the progress state of the attack on the information system 200.

More specifically, the progress state detection unit 153 detects the progress state of the attack on the information system 200 by relating it to any system component 300 of the plurality of system components 300.

When determination timing arrives, an information management unit 154 determines whether or not the candidate progress state indicated in the candidate progress state information 1522 coincides with the detected progress state which has been detected until the determination timing by the progress state detection unit 153. When the candidate progress state coincides with the detected progress state, the information management unit 154 deletes the candidate event information 1521 and the candidate progress state information 1522 from the information storage unit 152.

More specifically, the information management unit 154 determines whether or not the candidate progress state indicated in the candidate progress state information 1522 coincides with the detected progress state which has been detected until the determination timing by the progress state detection unit 153, and whether or not the candidate system component indicated in the candidate system component information 1523 coincides with the detected system component has been detected until the determination timing by the progress state detection unit 153. When the candidate progress state coincides with the detected progress state and the candidate system component coincides with the detected system component, the information management unit 154 deletes the candidate event information 1521, the candidate progress state information 1522, and the candidate system component information 1523 from the information storage unit 152.

***Description of Operation of Information Processing Apparatus 150***

Nextly, an operation example of the information processing apparatus 150 will be described.

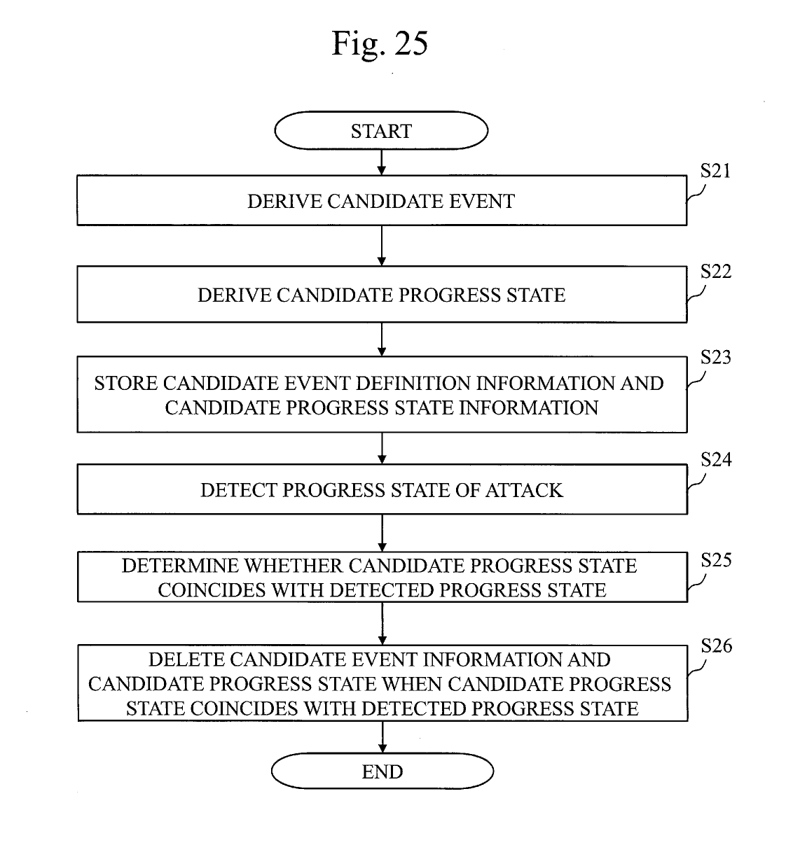

FIG. 25 is a flowchart diagram illustrating the operation example of the information processing apparatus 150.

In the present embodiment, without determining whether or not the candidate event is to be the monitoring target, the candidate event information 1521 and the like are stored in the information storage unit 152, and based on a current progress state of the attack, the candidate event information 1521 and the like of the candidate system monitoring to which has become unnecessary are deleted from the information storage unit 152.

Firstly, in S21, the candidate event derivation unit 151 derives the candidate event.

For example, when the candidate event derivation unit 101 is notified of the attack symptom event by the security device in the information system 200, the candidate event derivation unit 101 derives, as the candidate event, the event predicted to occur subsequent to the attack symptom event.

A method for deriving the candidate event is, for example, as illustrated in the first embodiment.

S21 is called candidate event deriving processing.

Nextly, in S22, the candidate event derivation unit 151 derives the candidate progress state being the progress state of the attack on the information system 200 when the candidate event occurs.

The candidate progress state is the achieved state of the candidate event derived in S21.

Further, the candidate event derivation unit 151 derives, as the candidate system component, the system component involved in the occurrence of the candidate event from among the plurality of system components 300.

Nextly, in S23, the information storage unit 152 stores the candidate event information 1521 in which the contents of the candidate event is indicated and the candidate progress state information 1522 in which the candidate progress state is indicated.

Further, the information storage unit 152 stores the candidate system component information 1523 in which the candidate system component is indicated.

S23 is called information storage processing.

Nextly, in S24, the progress state detection unit 153 detects the progress state of the attack on the information system 200.

More specifically, the progress state detection unit 153 detects the progress state of the attack on the information system 200 by relating it to any system component 300 of the plurality of system components 300.

For example, the progress state detection unit 153 receives the detection alert 400 described in the first embodiment and analyzes the detection alert 400 to detect the progress state of the attack on the information system 200.

S24 is called progress state detection processing.

The processing of S24 is repeated periodically or non-periodically.

Nextly, in S25, when the determination timing arrives, the information management unit 154 determines whether or not the candidate progress state indicated in the candidate progress state information 1522 coincides with the detected progress state which has been detected until the determination timing by the progress state detection unit 153, and whether or not the candidate system component indicated in the candidate system component information 1523 coincides with the detected system component has been detected until the determination timing by the progress state detection unit 153.

S25 is called information management processing.

Nextly, in S26, when the candidate progress state coincides with the detected progress state and the candidate system component coincides with the detected system component, the information management unit 154 deletes the candidate event information 1521, the candidate progress state information 1522, and the candidate system component information 1523 from the information storage unit 152.

***Description of Configuration of Attack Event Prediction Apparatus 85***

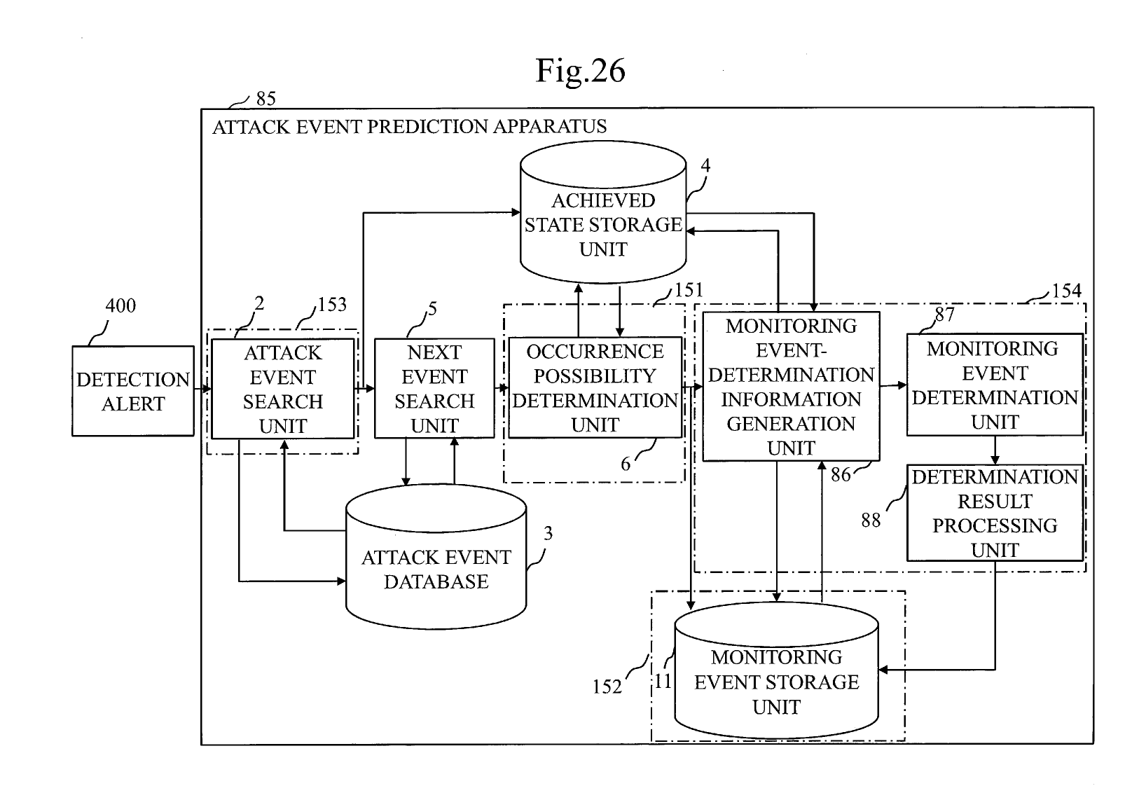

FIG. 26 illustrates a configuration example of an attack event prediction apparatus 85 according to the present embodiment.

The attack event prediction apparatus 85 is an apparatus that is further specified from the information processing apparatus 150 illustrated in FIG. 24.

As illustrated in FIG. 26, the attack event prediction apparatus 85 is configured with the attack event search unit 2, the attack event database 3, the achieved state storage unit 4, the next event search unit 5, the occurrence possibility determination unit 6, a monitoring event-determination information generation unit 86, a monitoring event determination unit 87, a determination result processing unit 88, and the monitoring event storage unit 11.

The attack event prediction apparatus 85 identifies, as with the attack event prediction apparatus of any other embodiments, the monitoring event being the monitoring target based on the detection alert 400 obtained from the outside.

In FIG. 26, the attack event search unit 2, the attack event database 3, the achieved state storage unit 4, the next event search unit 5, the occurrence possibility determination unit 6, and the monitoring event storage unit 11 are the same as the attack event search unit 2, the attack event database 3, the achieved state storage unit 4, the next event search unit 5, the occurrence possibility determination unit 6, and the monitoring event storage unit 11 of the first embodiment.

The monitoring event-determination information generation unit 86 operates with the derivation of the candidate event by the occurrence possibility determination unit 6 as a trigger.

The monitoring event-determination information generation unit 86 acquires all of the candidate event definition information described in the monitoring event storage unit 11, acquires all of the achieved state information described in the achieved state storage unit 4, and outputs the acquired candidate event definition information and achieved state information to the monitoring event determination unit 87.

The monitoring event determination unit 87 checks if there exists in the achieved state information an achieved state that coincides with a combination of the predicate logic of the achieved state of the candidate event and the bind value relating to the variable corresponding to the predicate logic, the candidate event being described in the candidate event definition information input form the monitoring event-determination information generation unit 86.

When there exists in the achieved state information the achieved state that coincides with the combination of the predicate logic and the bind value, the monitoring event determination unit 87 determines that the corresponding candidate event is not needed to be monitored.

The determination result processing unit 88 requires the monitoring event storage unit 11 to delete the candidate event definition information of the candidate event determined by the monitoring event determination unit 87 that monitoring is not needed.

Note that, the occurrence possibility determination unit 6 corresponds to the candidate event derivation unit 151 illustrated in FIG. 24, the monitoring event storage unit 11 corresponds to the information storage unit 152 illustrated in FIG. 24, and the attack event search unit 2 corresponds to the progress state detection unit 153 illustrated in FIG. 24.

Further, the monitoring event-determination information generation unit 86, the monitoring event determination unit 87, and the determination result processing unit 88 correspond to the information management unit 154 illustrated in FIG. 24.

***Description of Operation of Attack Event Prediction Apparatus 85***

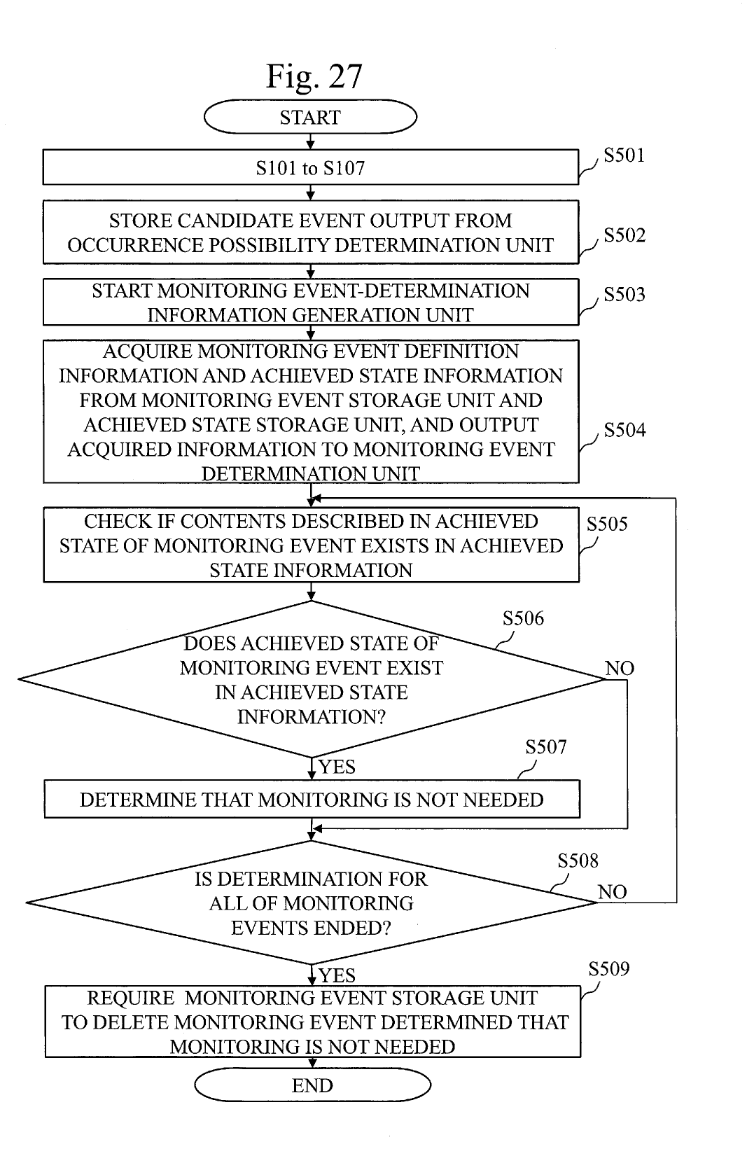

Nextly, an operation example of the attack event prediction apparatus 85 according to the fourth embodiment will be described with reference to FIG. 27.

FIG. 27 is a flowchart diagram illustrating a processing flow of the attack event prediction apparatus 85 according to the fourth embodiment.

Firstly, in a step S501, the same processing as S101 to S107 is performed.

In a step S502, the monitoring event storage unit 11 stores all of the candidate event definition information output from the occurrence possibility determination unit 6.

The candidate event definition information stored in the monitoring event storage unit 11 is called the monitoring event definition information.

That is, in the present embodiment, as described in the second embodiment, the separation between the candidate event being subjected to monitoring and the candidate event not being subjected to monitoring is not performed using the exclusion rule.

However, the separation between the candidate event being subjected to monitoring and the candidate event not being subjected to monitoring may be performed using the exclusion rule.

In a step S503, after a completion of the processing of S502, the occurrence possibility determination unit 6 starts the monitoring event-determination information generation unit 86.

In a step S504, the monitoring event-determination information generation unit 86 acquires from the monitoring event storage unit 11 all of the monitoring event definition information currently stored in the monitoring event storage unit 11.

Further, the monitoring event-determination information generation unit 86 acquires all of the achieved state information currently stored in the achieved state storage unit 4.

Further, the monitoring event-determination information generation unit 86 outputs the acquired monitoring event definition information and achieved state information to the monitoring event determination unit 87.

In a step S505, the monitoring event determination unit 87 checks if there exists in the achieved state information the achieved state that coincides with the combination of the predicate logic described in the achieved state of the monitoring event definition information and the bind value of the variable described in the predicate logic.

In a step S506, the processing branches depending on whether or not there exists in the achieved state information the achieved state that coincides with the combination of the predicate logic described in the monitoring event definition information and the bind value of the variable described in the predicate logic.

When there exists in the achieved state information the achieved state that coincides with the combination of the predicate logic of the achieved state and the bind value, the monitoring event determination unit 87 performs the processing of S507.

When there does not exists in the achieved state information the achieved state that coincides with the combination of the predicate logic of the achieved state and the bind value, the monitoring event determination unit 87 performs the processing of S508.

In a step S507, the monitoring event determination unit 87 determines that it is unnecessary to monitor the candidate event in which the combination of the predicate logic of the achieved state and the bind value coincides with the achieved state in the achieved state information.

That is, as a result of the progress of the attack on the information system 200, the achieved state of the monitoring event has already been fulfilled in the information system 200. Thus, it is no longer needed to continue monitoring this monitoring event so that the monitoring event determination unit 87 determines that this monitoring event is not needed to be monitored.

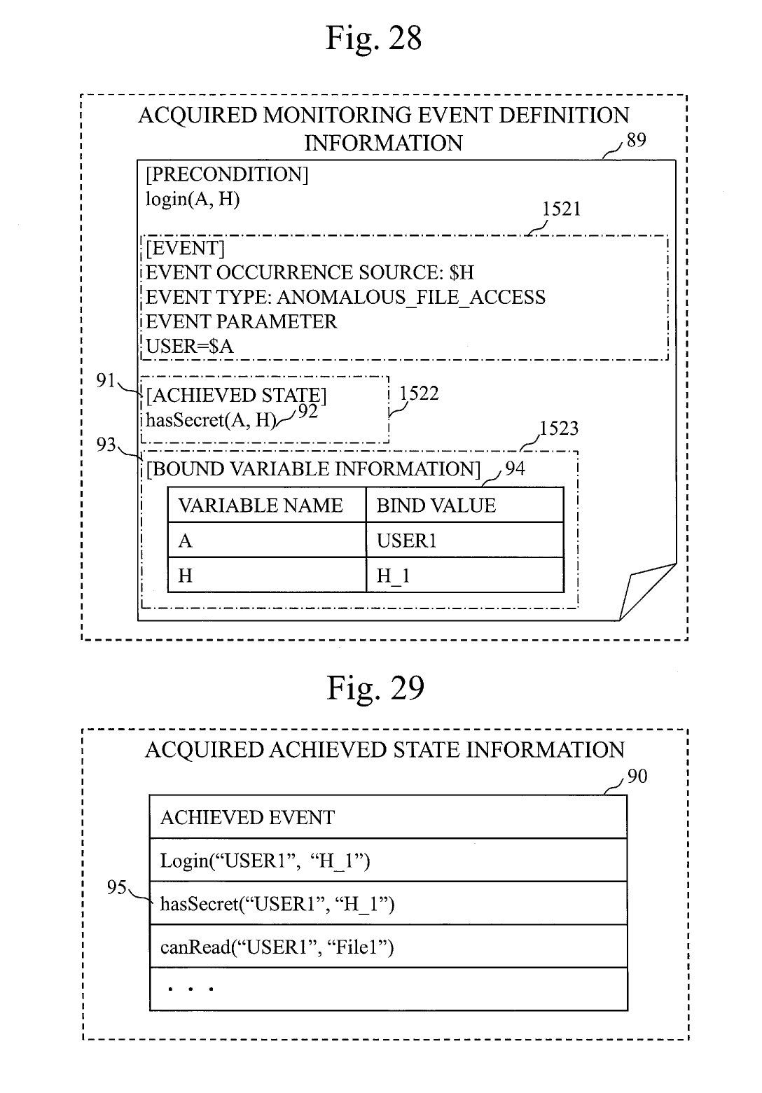

The processing of S507 will be described with reference to FIGS. 28 and 29.

FIG. 28 illustrates a monitoring event definition information 89 acquired from the monitoring event storage unit 11 by the monitoring event-determination information generation unit 86.

Further, FIG. 29 illustrates an achieved state information 90 acquired by the monitoring event-determination information generation unit 86.

A combination of the predicate logic of “hasSecret (A, H)” of an achieved state 91 of the monitoring event definition information 89 and values of “USER1” and “H_1” of a bind value 94 associated with the variable “A” and the variable “H” in a bound variable information 93 coincides with a predicate logic 95 of “hasSecret (“USER1”, “H_1”) in the achieved state information 90.

Therefore, the monitoring event determination unit 87 determines that it is unnecessary to monitor the monitoring event identified in a field of [EVENT] in the monitoring event definition information 89.

Back to FIG. 27, in a step S508, the processing branches depending on whether or not the processing from S505 to S507 is executed to all of the monitoring event definition information output from the monitoring event-determination information generation unit 86 in S504.

When the processing from S505 to S507 is executed to all of the monitoring event definition information, the processing of S509 is performed.

When the processing from S505 to S507 is not executed to one or more monitoring event definition information, the monitoring event determination unit 87 executes the processing from S505 to S507 to the monitoring event definition information to which the processing has not been executed.

In a step S509, the determination result processing unit 88 requires the monitoring event storage unit 11 to delete from the monitoring event storage unit 11 the monitoring definition information of the monitoring event determined in S507 that monitoring is not needed.

***Description of Advantageous Effects***

As just described, in the present embodiment, by comparing the state having already been achieved with the state to be achieved by the monitoring event, a monitoring event a state of which is prior to the state having already been achieved by a certain attack can be excluded from the monitoring target and the resource for monitoring the event can be effectively used.

### Fifth Embodiment

In the present embodiment, a management tool for managing various types of databases will be described.

***Description of Configurations***

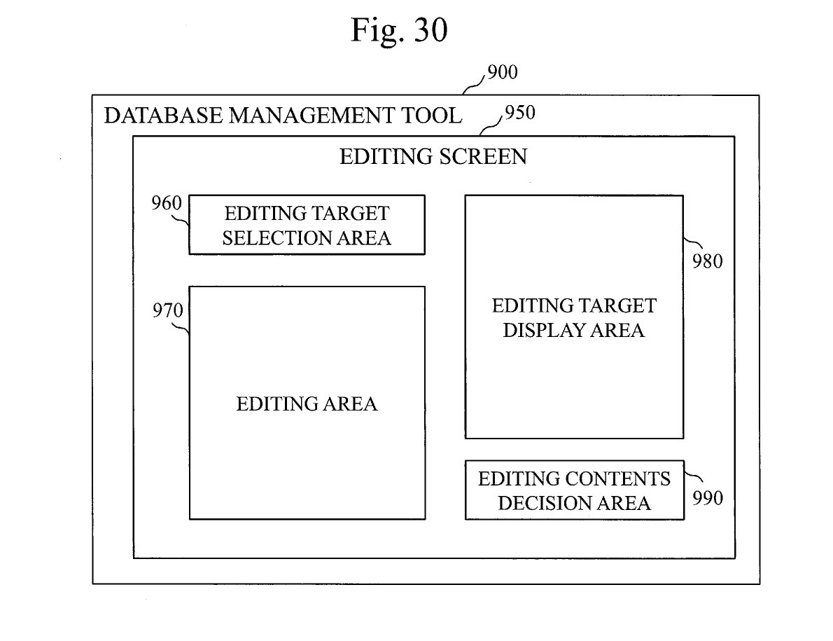

As illustrated in FIG. 30, a database management tool 900 according to the present embodiment presents an editing screen 950 to a user and performs editing an item included in a database when receiving an instruction from the user.

The database management tool 900 according to the present embodiment may be implemented to any of the attack event prediction apparatus 1 of the first embodiment, the attack event prediction apparatus 43 of the second embodiment, the attack event prediction apparatus 76 of the third embodiment, and the attack event prediction apparatus 85 of the fourth embodiment.

The database management tool adds, deletes, or changes the contents of various databases (for example, an attack event database and the like) used for the first to fourth embodiments.

The database management tool 900 corresponds to an example of a rule editing tool.

As illustrated in FIG. 30, the editing screen 950 is configured with a editing target selection area 960, an editing area 970, an editing target display area 980, and an editing contents decision area 990.

The editing target selection area 960 displays a candidate for a database to be edited, and makes the user select the database being an editing target.

The editing area 970 displays the details of the item of the database selected by the user, and receives the instruction for editing the contents.

The editing target display area 980 displays the database selected by the user in the editing target selection area 960, and enables the user to select the item within the displayed database.

The editing contents decision area 990 receives the instruction of an editing type such as adding, changing, or deleting the contents of the database selected by the user.

***Description of Operations***

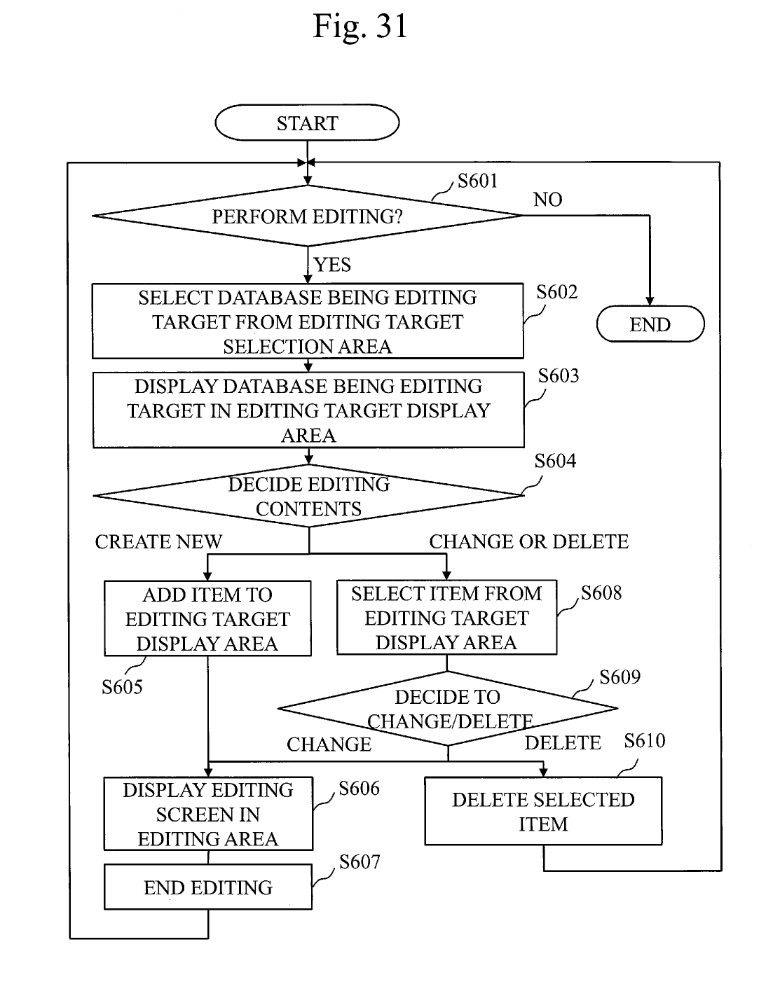

Nextly, an operation example of the database management tool 900 according to the fifth embodiment will be described with reference to FIG. 31.

FIG. 31 is a flowchart illustrating a processing flow of the database management tool 900 according to the fifth embodiment.

In a step S601, while the database management tool 900 displays the editing screen 950 on a display, the processing branches depending on whether or not the user performs editing.

When the user finishes editing, the processing ends.

When the user performs editing, the processing of S602 is performed.

In a step S602, the database management tool 900 displays the editable database in the editing target selection area 960, and the user selects the database being the editing target from the editing target selection area.

In a step S603, the database management tool 900 displays in the editing target display area 980 items included in the database selected by the user.

In a step S604, the processing branches depending on editing contents.

When an item is newly added (creating a new item) to the database, the processing of S605 is performed.

When the item of the database is changed or the item of the database is deleted, the processing of S608 is performed.

In a step S605, the database management tool 900 newly adds the item to the editing target display area 980, and the user selects the added item.

In a step S606, the database management tool 900 displays in the editing area 970 the item selected in S605, and the contents of the item become editable.

The user edits the item in the editing area 970.

When editing is completed in a step S607, the processing of S601 is performed.

In a step S608, the user selects an item to be changed or deleted from the items displayed in the editing target display area 980.

In a step S609, the processing branches depending on whether the item selected in S608 is to be changed or deleted.

When the item is to be changed, the processing of S606 is performed.

When the item is to be deleted, the processing of S610 is performed.

In a step S610, the database management tool 900 deletes the item selected in S608.

After that, the processing of S601 is performed.

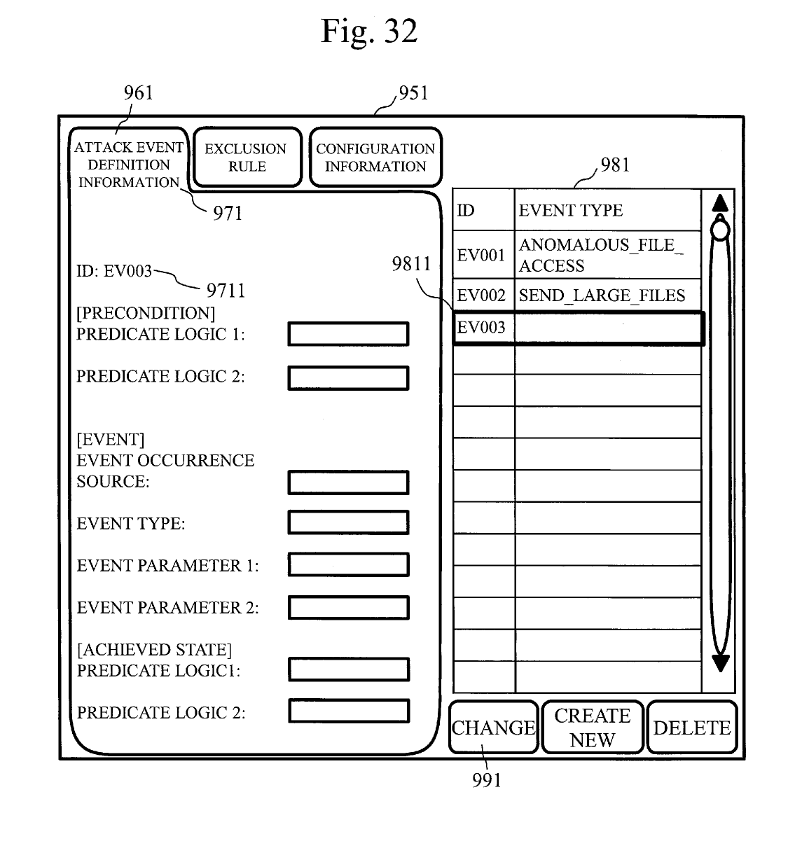

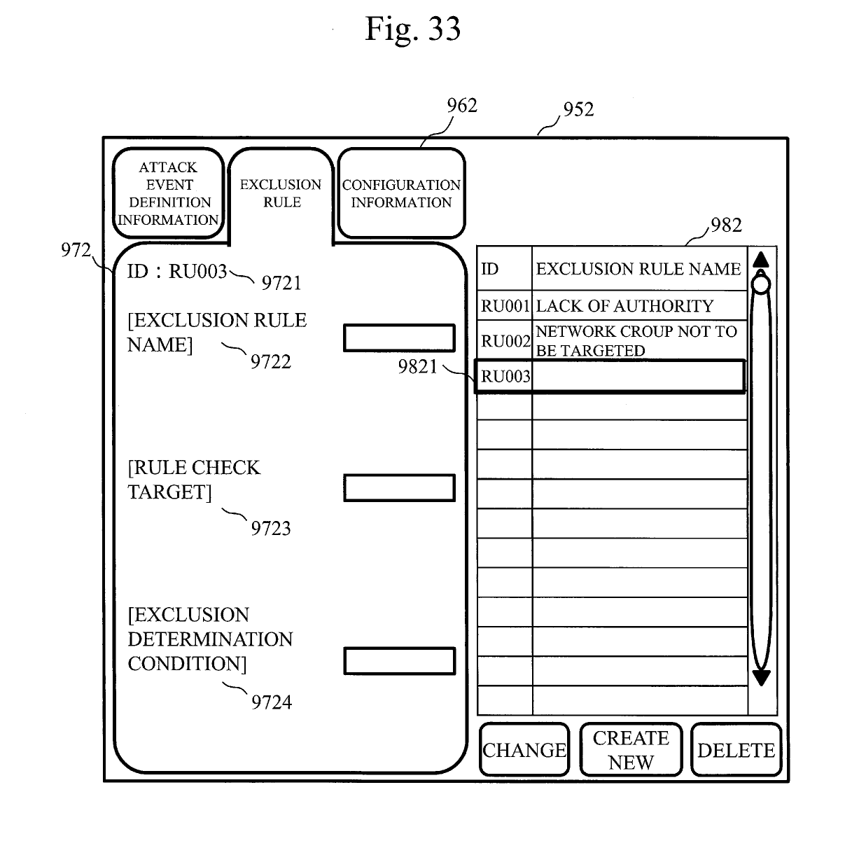

FIGS. 32 and 33 illustrate specific examples of the editing screen 950.

FIG. 32 illustrates an editing screen 951 for editing the attack event definition information.

FIG. 33 illustrates an editing screen 952 for editing the exclusion rule.

In the editing screen 951 of FIG. 32, an editing target selection area 961 has selection field of “attack event definition information”, “exclusion rule”, and “configuration information” for selecting the database to be edited.

FIG. 32 illustrates an example of the editing screen 951 in a state where the attack event definition information has been selected.

In an editing target display area 981, the breakdown of the attack event definition information is displayed.

In the editing target display area 981, for each item, an ID and an event type of the attack event definition information are displayed.

When the user selects the item displayed in the editing target display area 981, the detailed information of the attack event definition information is displayed in an editing area 971.

FIG. 32 illustrates a state where creating new attack event definition information has been selected in an editing contents decision area 991.

“EV003” of a reference sign 9811 is added to the editing target display area 981, and “EV003” is selected.

In the editing area 971, the editing screen for “EV003” with the reference sign 9811 selected in the editing target display area 981 is displayed.

In an ID 9711 of the attack event definition information, “EV003” is displayed and any other items are blank.

FIG. 33 illustrates an example of the editing screen 952 in a state where the exclusion rule has been selected in the editing target selection area 961.

In an editing target display area 982, the breakdown of the exclusion rule is displayed.

In the editing target display area 982, for each item, an ID and a name of the exclusion rule are displayed.

When the user selects the item displayed in the editing target display area 982, the detailed information of the exclusion rule is displayed in an editing area 972.

FIG. 33 illustrates a state where creating new exclusion rule has been selected in the editing target display area 982.

“RU003” of a reference sign 9821 is added to the editing target display area 982, and “RU003” is selected.

In the editing area 972, the editing screen for “RU003” with the reference sign 9821 selected in the editing target display area 982 is displayed.

In an ID 9721 of the attack event definition information, “RU003” is displayed, and any other items are blank.

In a rule name 9722, a name representing the exclusion rule is specified.

The user can arbitrary specify the name of the exclusion rule.

In a rule check target 9723, an event being a target for determination based on the exclusion rule is specified.

In an exclusion determination condition 9724, a condition for excluding the event from the monitoring target is specified.

***Description of Advantageous Effects***

As just described, according to the present embodiment, the user can easily edit the databases from the first embodiment to the fourth embodiment.

The embodiments of the present invention have been described above. Two or more of these embodiments may be implemented in combination.

Alternatively, one of these embodiments may be partially implemented.

Alternatively, two or more of these embodiments may be partially implemented in combination.

Note that, the present invention is not limited to these embodiments, and various modifications are possible as appropriate.

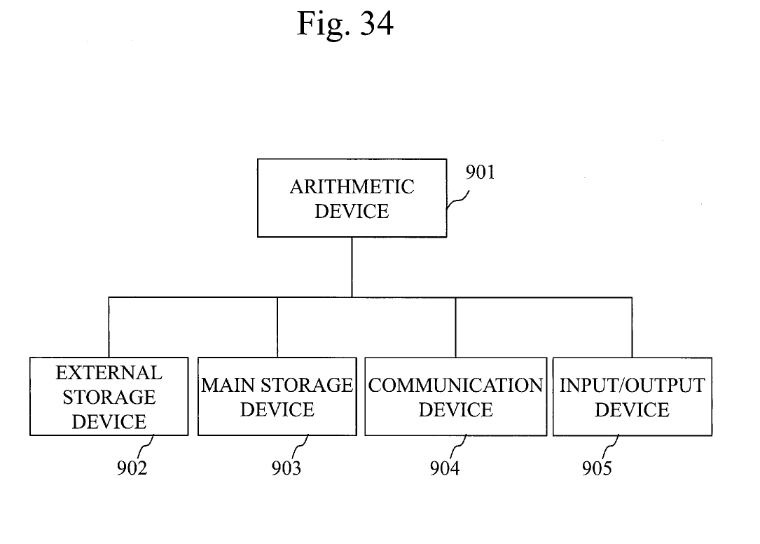

Lastly, a hardware configuration example of the information processing apparatus 100, the information processing apparatus 150, the attack event prediction apparatus 1, the attack event prediction apparatus 43, the attack event prediction apparatus 76, and the attack event prediction apparatus 85 (to be referred to as the information processing apparatus 100 and the like hereinafter) indicated in the first to fifth embodiments will be described with reference to FIG. 34.

The information processing apparatus 100 and the like are computers, and each element of the information processing apparatus 100 and the like can be implemented by a program.

As the hardware configuration of the information processing apparatus 100 and the like, an arithmetic device 901, an external storage device 902, a main storage device 903, a communication device 904, and an input/output device 905 are connected to a bus.

The arithmetic device 901 is a CPU (Central Processing Unit) that executes programs.

The external storage device 902 is, for example, a ROM (Read Only Memory), a flash memory, or a hard disk device.

The main storage device 903 is a RAM (Random Access Memory).

The communication device 904 is, for example, a NIC (Network Interface Card).

The input/output device 905 is, for example, a mouse, a keyboard, a display device, or the like.

The programs are usually stored in the external storage device 902 and are loaded into the main storage device 903 to be sequentially read and executed by the arithmetic device 901.

The programs are those which implement functions each described as “unit” (except for “storage unit”, the same applies hereinafter) illustrated in FIG. 1.

Further, the external storage device 902 also stores an operating system (OS), and at least a part of the OS is loaded into the main storage device 903. The arithmetic device 901 executes the programs each of which implements the function of “unit” illustrated in FIG. 1, while executing the OS.

Further, in the descriptions of the first to fifth embodiments, information, data, signal values, and variable values indicating the results of the processes described as “evaluate”, “determine”, “decide”, “identify”, “analyze”, “acquire”, “derive”, “extract”, “detect”, “set”, “check”, “select”, “generate”, “input”, “output”, and the like are stored as files in the main storage device 903.

Note that the configuration of FIG. 34 merely indicates the hardware configuration example of the information processing apparatus 100 and the like and the hardware configuration of the information processing apparatus 100 and the like is not limited to the configuration illustrated in FIG. 34, but may be another configuration.

Further, in accordance with the procedures indicated in the first to fifth embodiments, an information processing method according to the present invention can be realized.

### REFERENCE SIGNS LIST

1: attack event prediction apparatus; 2: attack event search unit; 3: attack event database; 4: achieved state storage unit; 5: next event search unit; 6: occurrence possibility determination unit; 7: monitoring event-determination information generation unit; 8: determination information database; 9: monitoring event determination unit; 10: determination result processing unit; 11: monitoring event storage unit; 43: attack event prediction apparatus; 44: monitoring event-determination information generation unit; 45: configuration information database; 46: monitoring event determination unit; 47: exclusion rule database; 48: determination result processing unit; 74: bound variable extraction unit; 75: configuration information acquisition unit; 76: attack event prediction apparatus; 77: monitoring event recovery processing unit; 78: exclusion event storage unit; 85: attack event prediction apparatus; 86: monitoring event-determination information generation unit; 87: monitoring event determination unit; 88: determination result processing unit; 100: information processing apparatus; 101: candidate event derivation unit; 102: attribute identification unit; 103: monitoring target decision unit; 150: information processing apparatus; 151: candidate event derivation unit; 152: information storage unit; 153: progress state detection unit; 154: information management unit; 200: information system; 300: system component; 400: detection alert; 900: database management tool; 950: editing screen; 960: editing target selection area; 970: editing area; 980: editing target display area; 990: editing contents decision area; 1521: candidate event information; 1522: candidate progress state information; and 1523: candidate system component information.

1-14. (canceled)

15. An information processing apparatus comprising:
processing circuitry to:
derive, as a candidate event, an event predicted to occur in an information system including a plurality of system components, the event being a candidate for a monitoring target;
derive, as a candidate system component, a system component involved in occurrence of the candidate event from among the plurality of system components, and identify an attribute of the candidate system component; and
acquire an exclusion rule in which a condition for an event which is to be excluded from the monitoring target is defined using an attribute of the system component, and decide whether or not the candidate event is to be the monitoring target by comparing the attribute of the candidate system component identified by the processing circuitry with the attribute of the system component defined in the exclusion rule.

16. The information processing apparatus according to claim 15,
wherein the processing circuitry derives, as the candidate event, an event predicted to occur in the information system when the information system is attacked.

17. The information processing apparatus according to claim 16,
wherein the processing circuitry derives, as the candidate event, an event predicted to occur in the information system subsequent to the attack symptom event when an attack symptom event being a symptom of the attack on the information system occurs.

18. The information processing apparatus according to claim 15,
wherein, when the attribute of the candidate system component coincides with the attribute of the system component defined in the exclusion rule, the processing circuitry excludes the candidate event from the monitoring target.

19. The information processing apparatus according to claim 15,
wherein, when the attribute of the candidate system component does not coincide with the attribute of the system component defined in the exclusion rule, the processing circuitry sets the candidate event to be the monitoring target.

20. The information processing apparatus according to claim 18,
wherein, when the exclusion rule is invalidated after excluding the candidate event from the monitoring target, the processing circuitry sets the candidate event to be the monitoring target.

21. The information processing apparatus according to claim 18, further comprising
a rule editing tool that edits the exclusion rule.

22. An information processing apparatus comprising:
processing circuitry to derive, as a candidate event, an event predicted to occur in an information system when the information system is attacked, and derive a candidate progress state being a progress state of the attack on the information system when the candidate event occurs; and
a memory to store candidate event definition information in which contents of the candidate event are indicated and candidate progress state information in which the candidate progress state is indicated;
wherein the processing circuitry detects the progress state of the attack on the information system and
determines, when determination timing arrives, whether or not the candidate progress state indicated in the candidate progress state information coincides with a detected progress state which has been detected until the determination timing, and when the candidate progress state coincides with the detected progress state, deletes the candidate event definition information and the candidate progress state information from the memory.

23. The information processing apparatus according to claim 22,
wherein, when an attack symptom event being a symptom of the attack on the information system occurs, the processing circuitry derives, as the candidate event, the event predicted to occur in the information system subsequent to the attack symptom event.

24. The information processing apparatus according to claim 23,
wherein the processing circuitry derives, as the candidate event, an event predicted occur in the information system when the information system including a plurality of system components is attacked, and
derives, as a candidate system component, a system component involved in occurrence of the candidate event from among the plurality of system components,
the memory stores candidate system component information in which the candidate system component is indicated,
the processing circuitry detects the progress state of the attack on the information system by relating it to any system component of the plurality of system components, and the processing circuitry determines, when the determination timing arrives, whether or not the candidate progress state indicated in the candidate progress state information coincides with the detected progress state which has been detected until the detection timing, and whether or not the candidate system component indicated in the candidate system component information coincides with a detected system component has been detected until the determination timing, and when the candidate progress state coincides with the detected progress state and the candidate system component coincides with the detected system component, deletes the candidate event definition information, the candidate progress state information, and the candidate system component information from the memory.

25. An information processing method comprising:
deriving, as a candidate event, an event predicted to occur in an information system including a plurality of system components, the event being a candidate for a monitoring target;
deriving, as a candidate system component, a system component involved in occurrence of the candidate event from among the plurality of system components, and identifying an attribute of the candidate system component; and
acquiring an exclusion rule in which a condition for an event which is to be excluded from the monitoring target is defined using an attribute of the system component, and deciding whether or not the candidate event is to be the monitoring target by comparing the identified attribute of the candidate system component with the attribute of the system component defined in the exclusion rule.

26. An information processing method comprising:
deriving, as a candidate event, an event predicted to occur in an information system when the information system is attacked, and deriving a candidate progress state being a progress state of the attack on the information system when the candidate event occurs;
storing to a storage apparatus, candidate event definition information in which contents of the candidate event are indicated and candidate progress state information in which the candidate progress state is indicated;
detecting, the progress state of the attack on the information system; and
determining, when determination timing arrives, whether or not the candidate progress state indicated in the candidate progress state information coincides with a detected progress state which has been detected until the determination timing, and when the candidate progress state coincides with the detected progress state, deleting the candidate event definition information and the candidate progress state information from the storage apparatus.

27. A non-transitory computer readable medium storing a program to cause a computer to execute:
candidate event deriving processing to derive, as a candidate event, an event predicted to occur in an information system including a plurality of system components, the event being a candidate for a monitoring target;
attribute identification processing to derive, as a candidate system component, a system component involved in occurrence of the candidate event from among the plurality of system components, and identify an attribute of the candidate system component; and
monitoring target decision processing to acquire an exclusion rule in which a condition for an event which is to be excluded from the monitoring target is defined using an attribute of the system component, and decide whether or not the candidate event is to be the monitoring target by comparing the attribute of the candidate system component identified by the attribute identification processing with the attribute of the system component defined in the exclusion rule.

28. A non-transitory computer readable medium storing a program to cause a computer to execute:
candidate event deriving processing to derive, as a candidate event, an event predicted to occur in an information system when the information system is attacked, and derive a candidate progress state being a progress state of the attack on the information system when the candidate event occurs;
information storage processing to store to a storage apparatus candidate event definition information in which contents of the candidate event are indicated and candidate progress state information in which the candidate progress state is indicated;
progress state detection processing to detect the progress state of the attack on the information system; and
information management processing to determine, when determination timing arrives, whether or not the candidate progress state indicated in the candidate progress state information coincides with a detected progress state which has been detected until the determination timing by the progress state detection processing, and when the candidate progress state coincides with the detected progress state, delete the candidate event definition information and the candidate progress state information from the storage apparatus.
